(19) United States
(12) Patent Application Publication
(10) Pub. No.: US 2022/0294588 A1
(43) Pub. Date: Sep. 15, 2022

(54) PUSCH DMRS DESIGN IN 2-STEP RANDOM ACCESS

(71) Applicant: Telefonaktiebolaget LM Ericsson (publ), Stockholm (SE)

(72) Inventors: Robert Mark HARRISON, Grapevine, TX (US); Zhipeng LIN, Nanjing Jiangsu (CN)

(21) Appl. No.: 17/633,323

(22) PCT Filed: Aug. 6, 2020
(86) PCT No.: PCT/SE2020/050770

§ 371 Date: Feb. 7, 2022

Related U.S. Application Data
(60) Provisional application No. 62/884,222, filed on Aug. 8, 2019.

(51) Int. Cl. H04L 5/00; H04W 74/08

(52) U.S. Cl. CPC H04L 5/0051; H04L 5/0014; H04W 74/0833

(57) ABSTRACT

Methods and apparatuses are disclosed for Physical Uplink Shared Channel (PUSCH) Demodulation Reference Signal (DMRS) design in, e.g., 2-step random access. In one embodiment, a wireless device configured to communicate with a network node is provided. The wireless device is configured to: receive an indication indicating at least one Demodulation Reference Signal, DMRS, parameter for a physical uplink shared channel, PUSCH in a 2-step random access procedure where the at least one DMRS parameter indicating a plurality of DMRS ports, and determine a subset of the plurality of DMRS ports for the PUSCH in the 2-step random access procedure.

### TECHNICAL FIELD

The present disclosure relates to wireless communications, and in particular, to Physical Uplink Shared Channel (PUSCH) Demodulation Reference Signal (DMRS) design in 2-step random access.

### BACKGROUND

Random access is performed by a wireless device (WD), such as, a user equipment (UE), in 3^{rd} Generation Partnership Project (3GPP) New Radio (NR) (also known as “5G”) and Long Term Evolution (LTE) networks when accessing a new cell. Once the random access procedure is completed, the WD is connected and the communication can continue using dedicated transmissions.

### 4 Step Random Access Procedure in NR

In NR, a 4-step approach is used for the random access procedure, see FIG. 1 as an example. In this approach, the WD detects a synchronization signal (SS) and decodes the broadcasted system information (which may be distributed over multiple physical channels, such as Physical Broadcast Channel (PBCH) and Physical Downlink Shared Channel (PDSCH)) to acquire random access transmission parameters, followed by the WD transmitting a Physical Random Access Channel (PRACH) preamble (message 1) in the uplink.

The network node (e.g., gNB) detects message 1 and replies with a Random Access Response (RAR) message (message 2). The WD then transmits a WD identification (message 3) on the Physical Uplink Shared Channel (PUSCH). The WD transmits PUSCH (message 3) after receiving a timing advance command in the RAR and after adjusting the timing of the PUSCH transmission, allowing PUSCH to be received at the network node (e.g., gNB) with a timing accuracy within the cyclic prefix (CP). Without this timing advance functionality, a very large CP would be needed in order to be able to demodulate and detect PUSCH, unless the system is applied in a cell with a very small distance between the WD and the network node (e.g., gNB). Since NR will also support larger cells, providing a timing advance to the WD may be used, and thus the 4-step approach is used for random access procedure.

### 2-Step RACH Work Item for Release 16 in Third Generation Partnership Project (3GPP)

A 2-step RACH work item has been approved in RAN1 #82 plenary meeting where completing the initial access in only two steps (message A and B) as illustrated in FIG. 2 may be specified. The first steps of detecting SSB and system information are the same as in the 4-step approach but then are followed by only two steps in order to minimize the number of channel accesses (which can be important for example in operation in unlicensed frequency bands where listen before talk must be performed before transmission):

Step 1: WD sends a message A including a random access preamble together with higher layer data such as Radio Resource Control (RRC) connection request possibly with some small additional payload on PUSCH; and

Step 2: The network node (e.g., gNB) sends RAR (denoted message B) including WD identifier assignment, timing advance information, and contention resolution message, etc.

### Demodulation Reference Signal (DMRS) Design in NR Release 15

In NR, DMRS design can be categorized as below in different aspects. As is shown in FIG. 3, DMRS can be either single symbol or double-symbol based, where double symbol based is only used for dedicated Physical Downlink Shared Channel (PDSCH) and PUSCH transmissions.

Frequency mapping of DMRS can be seen in FIG. 4, for example, where 2 types of mapping are defined, as follows (before RRC connection, DMRS Type 1 is used):

DMRS Type 1: Comb-based with 2 CDM (Code Division Multiplexing) groups; and

DMRS Type 2: Non-comb based with 3 CDM* groups.

The OFDM Symbol mapping of DMRS without symbols within the slot can be seen in FIG. 5, for example, where the mapping depends on the scheduling type (dynamically indicated in the Downlink Control Information (DCI) that schedules the PDSCH, or PUSCH transmission), as follows:
a) Type A: Slot-based scheduling

i) DMRS starts in symbol 3 or 4 from slot boundary (depending on configuration indication in PBCH); and
b) Type B: Non-slot-based scheduling

i) DMRS starts in PDSCH or PUSCH symbol 1 (unless DMRS collides with a Physical Downlink Control Channel (PDCCH), in which case DMRS is moved to the first available symbol later in time).

As seen in FIG. 5, additional DMRS symbols (1, 2 or 3 additional) could be configured. By default, two additional symbols are configured (e.g., to be used before RRC configuration), which can be changed for dedicated PDSCH and PUSCH transmissions. Generally, a default of two additional symbols is always used when scheduled by the fallback DCI formats 0_0 and 1_0. In addition, the FIG. 5 shows the nominal DMRS patterns, assuming the nominal full length slot (i.e., 14 symbols for Type A) and if the duration of PDSCH or PUSCH is shorter, then DMRS symbols may be dropped. For example, even if two additional (i.e., in total three) symbols are configured, the actual number of DMRS symbols used for a transmission can be fewer if the PDSCH or PUSCH duration is less than the nominal length.

DMRS port multiplexing is illustrated in FIG. 6, for example, where a maximum 4 or 8 ports can be multiplexed with type 1 DMRS and a maximum 6 or 12 ports can be multiplexed with type 2 DMRS for single and double symbol DMRS, respectively. Both frequency division multiplexing (FDM), and frequency division- orthogonal cover codes (FD-OCC) as well as time division-orthogonal cover codes (TD-OCC) is used to separate the orthogonal antenna ports.

The OCC may be FD-OCC only for single-symbol DMRS and may be both FD-OCC and TD-OCC for multiplexing of the DMRS ports for 2-symbol DMRS.

FIG. 7 provides an example of double-symbol Type 1 DMRS ports multiplexing with both FD-OCC and TD-OCC, where r(i) is one sample of the DMRS sequence, and one PRB is illustrated on 2 OFDM symbols with DMRS. As can be seen 2 OCC code in frequency domain, 2 OCC code in time domain, and 2 Code Division Multiplexing (CDM) groups provide 8 DMRS ports.

DMRS can be transmitted in an orthogonal fashion by transmitting the DMRS in Resource Elements (REs) not occupied by other DMRSs (i.e., by FDM), or using a different orthogonal cover code (‘OCC’) from DMRSs that occupy the same REs. Since the number of orthogonal DMRSs is limited by the number of REs that the DMRS occupies, it may be desirable to support non-orthogonal DMRSs as well to increase the multiplexing capacity. DMRS generation in NR supports both orthogonal and non-orthogonal DMRS generation, as can be understood by 3GPP Technical Specification (TS) 38.211, section 6.4.1.1.1.1 excerpted below, as follows:
6.4.1.1.1.1 Sequence generation when transform precoding is disabled

If transform precoding for PUSCH is not enabled, the sequence r(n) shall be generated according to

$$r ( n ) = \frac{1}{\sqrt{2}} ( 1 - 2 \cdot c ( 2 n ) ) + j \frac{1}{\sqrt{2}} ( 1 - 2 \cdot c ( 2 n + 1 ) ) .$$

where the pseudo-random sequence c(i) is defined in clause 5.2.1. The pseudo-random sequence generator shall be initialized with

cᵢₙᵢₜ=(2¹⁷(N_{symb}^{slot}n_{s,f}^{μ}+l+1)(2N_{ID}ⁿ^{_{SCID}}+1)+2N_{ID}ⁿ^{_{SCID}}+n_{SCID})mod 2³¹

where l is the OFDM symbol number within the slot, n_{s,f}^{μ} is the slot number within a frame, and
N_{ID}⁰, N_{ID}¹∈{0, 1, . . . , 65535} are given by the higher-layer parameters scramblingID0 and scramblingID1, respectively, in the DMRS-UplinkConfig IE if provided and the PUSCH is scheduled by DCI format 0_1 or by a PUSCH transmission with a configured grant;
N_{ID}⁰∈{0, 1, . . . , 65535} is given by the higher-layer parameter scramblingID0 in the DMRS-UplinkConfig IE if provided and the PUSCH is scheduled by DCI format 0_0 with the CRC scrambled by C-RNTI, MCS-C-RNTI, or CS-RNTI;
N_{ID}ⁿ^{_{SCID}}=N_{ID}^{cell} otherwise.

The quantity n_{SCID}∈{0,1} is indicated by the DM-RS initialization field, if present, either in the DCI associated with the PUSCH transmission if DCI format 0_1 in [4, TS 38.212] is used or by the higher layer parameter dmrs-SeqInitialization, if present, for a Type 1 PUSCH transmission with a configured grant, otherwise n_{SCID}=0.

6.4.1.1.1.2 Sequence Generation When Transform Precoding is Enabled

If transform precoding for PUSCH is enabled, the reference-signal sequence r(n) shall be generated according to

r(n)=r_{u,v}^{(α,δ)}(n)

n=0, 1, . . . , M_{sc}^{PUSCH}/2^{δ}−1
where r_{u,v}^{(α,δ)}(m) is given by clause 5.2.2 with δ=1 and α=0 for a PUSCH transmission.

The sequence group u =(f_{gh}+n_{ID}^{RS})mod 30, where n_{ID}^{RS} is given by
n_{ID}^{RS}=n_{ID}^{PUSCH} is configured by the higher-layer parameter nPUSCH-Identity in the DMRS-UplinkConfig IE and the PUSCH is not a msg3 PUSCH according to clause 8.3 in [5, TS 38.213].
n_{ID}^{RS}=N_{ID}^{cell} otherwise
where f_{gh} and the sequence number v are given by:
if neither group, nor sequence hopping is enabled
   f_{gh}=0
   v=0
if group hopping is enabled and sequence hopping is disabled

f_{gh}=(Σₘ₌₀⁷2^{m}c(8(N_{symb}^{slot}n_{s,f}^{μ}+l)+m)) mod 30
v=0
   where the pseudo-random sequence c(i) is defined by clause 5.2.1 and shall be initialized with cᵢₙᵢₜ=└n_{ID}^{RS}/30┘ at the beginning of each radio frame
if sequence hopping is enabled and group hopping is disabled

$${f}_{g h} = 0 \\ v = \{ \begin{matrix}c ( {N}_{symb}^{slot} {n}_{s , f}^{μ} + l ) & if {M}_{z c} \geq 6 {N}_{s c}^{R B} \\ 0 & otherwise\end{matrix}$$

where the pseudo-random sequence c(i) is defined by clause 5.2.1 and shall be initialized with cᵢₙᵢₜ=n_{ID}^{RS} at the beginning of each radio frame.

The hopping mode is controlled by higher-layer parameters:
for msg3 transmission on PUSCH, sequence hopping is disabled and group hopping is enabled or disabled by the higher-layer parameter groupHoppingEnabledTransformPrecoding;
for all other transmissions, sequence hopping and group hopping are enabled or disabled by the respective higher-layer parameters sequenceHopping and sequenceGroupHopping if these parameters are provided, otherwise, the same hopping mode as for msg3 shall be used.

The WD is not expected to handle the case of combined sequence hopping and group hopping. The quantity l above is the OFDM symbol number except for the case of double-symbol DMRS in which case l is the OFDM symbol number of the first symbol of the double-symbol DMRS.

Here the sequence r(i) can be configured differently for different WDs, hence even if the WDs use the same FDM, TD-OCC and FD-OCC, they can be separated by the use of different sequences r(i).

Considering first the DMRS when transform precoding is not used, since the sequence c(i) is pseudo random, it can be said to scramble the DMRS sequence generating sequence r( ) Furthermore, initializing c(i) with a different initialization value cᵢₙᵢₜ from that of another DMRS will cause the two DMRSs corresponding to a given antenna port to be non-orthogonal. Since cᵢₙᵢₜ depends on N_{ID}⁰ and/or N_{ID}¹ and both of these parameters can be signaled to each WD independently of other WDs, they can be said to be scrambling IDs for the DMRS used by the WD. When N_{ID}⁰ or N_{ID}¹ used by a WD is different from the N_{ID}⁰ or N_{ID}¹ used by another WD, the DMRS sequences of the two WDs for a given DMRS port are not orthogonal for a given antenna port. However, if N_{ID}⁰ and N_{ID}¹ are the same as the N_{ID}⁰ and N_{ID}¹ used by another WD, transmissions by the WDs on different DMRS ports will be orthogonal according to the construction of DMRS in 3GPP TS 38.211.

Next, considering the DMRS when transform precoding is used, since the sequence r_{u,v}^{(α,δ)}(m) is Zadoff-Chu sequence, it can be said to apply different cyclic shifts and root values of the root sequence to generate sequence r( ).
Considering the same cyclic shift: furthermore, applying different groups, i.e., u values for two DMRSs corresponding to a given antenna port will generate 2 non-orthogonal DMRS sequences. Since u depends on f_{gh}and n_{ID}^{RS} and both of these parameters can be signaled by dedicated signalling from the network node to each WD independently of other WDs, they can be interpreted to be scrambling identifiers (IDs) for the DMRS used by the WD. When f_{gh}and n_{ID}^{RS} used by a WD is different from the f_{gh}and n_{ID}^{RS} used by another WD, the DMRS sequences of the two WDs for a given DMRS port are not orthogonal for a given antenna port. However, if f_{gh}and n_{ID}^{RS} are the same as the f_{gh}and n_{ID}^{RS} used by another WD, transmissions by the WDs on different DMRS ports will be orthogonal according to the construction of DMRS in, for example, 3GPP TS 38.211.
Considering different cyclic shift values v within same group u: v can be considered to be scrambling IDs for the DMRS used by WD.

Thus, in general, the different combinations of {u, } can be interpreted as and thus be considered to be scrambling IDs for the DMRS used by the WD when transform precoding is used.

### Demodulation Reference signal (DMRS) Design for msg3 in 4-Step Random Access

According to section 2.1.3 (of 3GPP TS 38.211), for PUSCH carrying message 3, N_{ID}ⁿ^{_{SCID}}=N_{ID}^{cell}(CP-OFDM) or n_{ID}^{RS}=N_{ID}^{cell}(DFT-S-OFDM) are used for

DMRS sequence initialization, and DMRS type 1, single-symbol based DMRS are always used in random access procedure since these are the default DMRS configurations prior to dedicated RRC configurations.

For normal slot allocation for PUSCH, 1 front loaded+2 additional symbols for normal slot allocation (for PDSCH type A scheduling) is the default DMRS configuration and thus used for random access procedure.

For non-slot based (Type B) scheduling with frequency hopping disabled, Table 6.4.1.1.3-3 in TS 38.211 (reproduced herein below) gives the number of DMRS and DMRS positions using the Type B column and dmrs-AdditionalPosition=2 is used for random access procedure since it is the default configuration.

The actual number of DMRS symbols for a PUSCH transmission can be 1, 2 or 3 depending on the PUSCH duration (if frequency hopping is disabled).

Table 6.4.1.1.3-3 in 38.211 V15.4.0: PUSCH DM-RS positions
l̅ within a slot for single-symbol DM-RS
and intra-slot frequency hopping disabled.

| | DM-RS positions l̅ | | | | | | | |
|---|---|---|---|---|---|---|---|---|
| l_{d} in | PUSCH mapping type A | | | | PUSCH mapping type B | | | |
| sym- | dmrs-AdditionalPosition | | | | dmrs-AdditionalPosition | | | |
| bols | 0 | 1 | 2 | 3 | 0 | 1 | 2 | 3 |
| <4 | — | — | — | — | l₀ | l₀ | l₀ | l₀ |
| 4 | l₀ | l₀ | l₀ | l₀ | l₀ | l₀ | l₀ | l₀ |
| 5 | l₀ | l₀ | l₀ | l₀ | l₀ | l₀, 4 | l₀, 4 | l₀, 4 |
| 6 | l₀ | l₀ | l₀ | l₀ | l₀ | l₀, 4 | l₀, 4 | l₀, 4 |
| 7 | l₀ | l₀ | l₀ | l₀ | l₀ | l₀, 4 | l₀, 4 | l₀, 4 |
| 8 | l₀ | l₀, 7 | l₀, 7 | l₀, 7 | l₀ | l₀, 6 | l₀, 3, 6 | l₀, 3, 6 |
| 9 | l₀ | l₀, 7 | l₀, 7 | l₀, 7 | l₀ | l₀, 6 | l₀, 3, 6 | l₀, 3, 6 |
| 10 | l₀ | l₀, 9 | l₀, 6, 9 | l₀, 6, 9 | l₀ | l₀, 8 | l₀, 4, 8 | l₀, 3, 6, |
| | | | | | | | | 9 |
| 11 | l₀ | l₀, 9 | l₀, 6, 9 | l₀, 6, 9 | l₀ | l₀, 8 | l₀, 4, 8 | l₀, 3, 6, |
| | | | | | | | | 9 |
| 12 | l₀ | l₀, 9 | l₀, 6, 9 | l₀, 5, 8, | l₀ | l₀, 10 | l₀, 5, | l₀, 3, 6, |
| | | | | 11 | | | 10 | 9 |
| 13 | l₀ | l₀, 11 | l₀, 7, | l₀, 5, 8, | l₀ | l₀, 10 | l₀, 5, | l₀, 3, 6, |
| | | | 11 | 11 | | | 10 | 9 |
| 14 | l₀ | l₀, 11 | l₀, 7, | l₀, 5, 8, | l₀ | l₀, 10 | l₀, 5, | l₀, 3, 6, |
| | | | 11 | 11 | | | 10 | 9 |

Alternatively, if frequency hopping is enabled, then dmrs-AdditionalPosition equals to ‘pos1’ and Table 6.4.1.1.3-6 (reproduced herein below) is used with the Type B column; therefore, 1 or 2 DMRS symbols are transmitted depending on the PUSCH duration.

The list of applicable PUSCH durations for RAR is given by Table 6.1.2.1.1-2 in TS 38.214, where it can be seen for non-slot based scheduling that there are

PUSCH durations 6, 8 and 10 symbols (using the rows with Type B and the L column which means length in OFDM symbols). This means the two- and three-symbol DMRS per PUSCH are used for RAR messages.

Table 6.4.1.13-6 in 38.211
V15.4.0: PUSCH DM-RS positions l̅ within a slot
for single-symbol DM-RS and intra-slot frequency hopping enabled.

| | DM-RS positions l̅ | | | | | | | | | | | |
|---|---|---|---|---|---|---|---|---|---|---|---|---|
| | | | | | | | | | PUSCH mapping | | | |
| | PUSCH mapping type A | | | | | | | | type B | | | |
| | l₀ = 2 | | | | l₀ = 3 | | | | l₀ = 0 | | | |
| | dmrs- | | | | dmrs- | | | | dmrs- | | | |
| | AdditionalPosition | | | | AdditionalPosition | | | | AdditionalPosition | | | |
| | 0 | | 1 | | 0 | | 1 | | 0 | | 1 | |
| l_{d} in | 1^{st} | 2^{nd} | 1^{st} | 2^{nd} | 1^{st} | 2^{nd} | 1^{st} | 2^{nd} | 1^{st} | 2^{nd} | 1^{st} | 2^{nd} |
| symbols | hop | hop | hop | hop | hop | hop | hop | hop | hop | hop | hop | hop |
| ≤3 | — | — | — | — | — | — | — | — | 0 | 0 | 0 | 0 |
| 4 | 2 | 0 | 2 | 0 | 3 | 0 | 3 | 0 | 0 | 0 | 0 | 0 |
| 5, 6 | 2 | 0 | 2 | 0, 4 | 3 | 0 | 3 | 0, 4 | 0 | 0 | 0, 4 | 0, 4 |
| 7 | 2 | 0 | 2, 6 | 0, 4 | 3 | 0 | 3 | 0, 4 | 0 | 0 | 0, 4 | 0, 4 |

Table 6.1.2.1.1-2 in 38.214
V15.4.0: Default PUSCH time domain resource
allocation A for normal CP

| | PUSCH | | | |
|---|---|---|---|---|
| | mapping | | | |
| Row index | type | K₂ | S | L |
| 1 | Type A | j | 0 | 14 |
| 2 | Type A | j | 0 | 12 |
| 3 | Type A | j | 0 | 10 |
| 4 | Type B | j | 2 | 10 |
| 5 | Type B | j | 4 | 10 |
| 6 | Type B | j | 4 | 8 |
| 7 | Type B | j | 4 | 6 |
| 8 | Type A | j + 1 | 0 | 14 |
| 9 | Type A | j + 1 | 0 | 12 |
| 10 | Type A | j + 1 | 0 | 10 |
| 11 | Type A | j + 2 | 0 | 14 |
| 12 | Type A | j + 2 | 0 | 12 |
| 13 | Type A | j + 2 | 0 | 10 |
| 14 | Type B | j | 8 | 6 |
| 15 | Type A | J + 3 | 0 | 14 |
| 16 | Type A | J + 3 | 0 | 10 |

It is noted that DMRS port 0 is always used for msg3 PUSCH transmissions.

### Progress on Specifying msgA PUSCH Behavior for 2-Step RACH

Efforts to determine exactly how to specify msgA PUSCH thus far define a rough structure, where a PUSCH carrying msgA can be transmitted in periodically occurring resources, or ‘PUSCH occasions’, which are abbreviated as ‘POs’. Each PUSCH occasion can contain multiple PUSCH resource units, or ‘PUSCH RUs’, where a PUSCH RU is defined as the PO and a DMRS used to transmit in the PO. It has not yet been decided if the DMRS will be identified by its port number, its sequence initialization, or a combination of the port number and sequence initialization. Parameters including the location, timing, and PUSCH configuration of these POs are provided by higher Open Systems Interconnection (OSI) layer signalling.

Some discussions from the 3GPP RAN1 standards group may be summarized as follows:

One or more PUSCH occasion(s) within an msgA PUSCH configuration period are configured.
For further study (FFS) msgA PUSCH configuration period, e.g.
   For opt. 1 with separate PUSCH configuration, msgA PUSCH configuration period may or may not be the same as PRACH configuration period
      For opt. 2 PUSCH configuration with relative location, msgA PUSCH configuration period is the PRACH configuration period.

PUSCH resource unit for 2-step RACH may be defined as:
The PUSCH occasion and DMRS port/DMRS sequence used for an msgA payload transmission.
   FFS support only one or both of DMRS port/DMRS sequence
   The DMRS sequence generation mechanism should follow Re1.15.

The following parameters may be defined per msgA PUSCH configuration:
Common parameters for both option 1 (separate configuration) and option 2 (relative location), at least include:
   MCS and/or TBS (to be further decided)
   Number of FDMed POs
      POs (including guard band or guard period, if exist) under the same msgA PUSCH configurations are consecutive in frequency domain
   Number of PRBs per PO
   Number of DMRS symbols/ports/sequences (if support) per PO
   FFS whether or not support repetitions for msgA PUSCH
   FFS bandwidth of PRB-level guard band or duration of guard time
   FFS PUSCH mapping type
Parameters specific to option 1, at least include:
   Periodicity (msgA PUSCH configuration period)
      FFS value range
   Offset(s) (e.g., symbol, slot, subframe, etc.)
   Time domain resource allocation, details FFS, e.g., in a slot for msgA PUSCH: starting symbol, number of symbols per PO, number of time-domain POs, etc.
   Frequency starting point
Parameters specific to option 2, at least include:
   Single time offset (combination of slot-level and symbol-level indication) with respect to a reference point
      FFS, e.g., each PRACH slot (e.g., start or end of the PRACH slot), etc.
   Number of symbols per PO
      FFS explicit or implicit indication
   Single frequency offset with respect to FFS (the start of the first RO in frequency or the end of the last RO in frequency)
FFS: Number of TDMed POs

Support multiple msgA PUSCH configurations for a WD
FFS the maximum number of configurations
FFS which parameters, if any, are common for all configurations
FFS indication of different msgA PUSCH configurations, e.g. by different ROs, by different preamble groups, or by UCI
FFS whether or not resources for different msgA PUSCHs can be overlapped in time-frequency, and if so, any spec impact

FFS whether the frequency resource of msgA PUSCH should be limited to the bandwidth of PRACH

FFS validation rule of msgA PUSCH

A problem exists as to how to define behavior and methods for DMRS of PUSCH carrying msgA for 2-step random access.

### SUMMARY

Some embodiments advantageously provide methods and apparatuses for Physical Uplink Shared Channel (PUSCH) Demodulation Reference Signal (DMRS) design in a e.g., 2-step random access.

In one embodiment, a method implemented in a network node includes signaling an indication of at least one Demodulation Reference Signal (DMRS) parameter for a 2-step random access procedure; and receiving a physical channel in the 2-step random access procedure according to the at least one DMRS parameter.

In another embodiment, a method implemented in a wireless device (WD) includes determine at least one Demodulation Reference Signal (DMRS) parameter for a 2-step random access procedure; and transmitting a physical channel in the 2-step random access procedure according to the determined at least one DMRS parameter.

According to one aspect of the disclosure, a wireless device configured to communicate with a network node is provided. The wireless device is configured to: receive an indication indicating at least one Demodulation Reference Signal, DMRS, parameter for a physical uplink shared channel, PUSCH in a 2-step random access procedure, the at least one DMRS parameter indicating a plurality of DMRS ports; and determine a subset of the plurality of DMRS ports for the PUSCH in the 2-step random access procedure.

According to one or more embodiments of this aspect, the determination of the subset of the plurality of DMRS ports is based on selecting a plurality of antenna ports from a plurality of code-division multiplexing, CDM, groups. According to one or more embodiments of this aspect, the determination of the subset of the plurality of DMRS ports includes: determining a first antenna port index of a first CDM group of the plurality of CDM groups that has a smallest index value among the first CDM group; selecting a first antenna port corresponding to the first antenna port index for inclusion in the subset of the plurality of DMRS ports; determining a second antenna port index of a second CDM group of the plurality of CDM groups that has a smallest index value among the second CDM group; and selecting a second antenna port corresponding to the second antenna port index for inclusion in the subset of the plurality of DMRS ports. According to one or more embodiments of this aspect, the selection of the plurality of antenna ports includes: interleaving the selection of the plurality of antenna ports among the plurality of CDM groups based at least on an antenna port index in each CDM group.

According to one or more embodiments of this aspect, the interleaving of the selection of the plurality of antenna ports begins at the smallest index value of an antenna port index in each CDM group. According to one or more embodiments of this aspect, the at least one DMRS parameter indicates a plurality of DMRS sequence initializations. The wireless device is further configured to select a DMRS sequence initialization from the plurality of DMRS sequence initialization for use with the subset of the plurality of DMRS ports. According to one or more embodiments of this aspect, the selection of the DMRS sequence initialization is based on at least one of: a physical random access channel, PRACH, occasion for transmission of a preamble of the 2-step random access procedure; an index of the preamble of the 2-step random access procedure; and an index of a PUSCH resource unit.

According to one or more embodiments of this aspect, the wireless device is further configured to cause transmission of a physical channel in the 2-step random access procedure according to the determined subset of the plurality of DMRS ports. According to one or more embodiments of this aspect, the transmission of the physical channel in the 2-step random access procedure corresponds to transmission of a message A, msgA, in the PUSCH during the 2-step random access procedure.

According to another aspect of the disclosure, a network node configured to communicate with a wireless device is provided. The network node is configured to: signal an indication indicating at least one Demodulation Reference Signal, DMRS, parameter for a physical uplink shared channel, PUSCH in a 2-step random access procedure where the at least one DMRS parameter indicates a plurality of DMRS ports; and receive a physical channel in the 2-step random access procedure according to a subset of the plurality of DMRS ports for the PUSCH in the 2-step random access procedure.

According to one or more embodiments of this aspect, the subset of the plurality of DMRS ports is based on a plurality of code-division multiplexing, CDM, groups. According to one or more embodiments of this aspect, the subset of the plurality of DMRS ports is based on interleaving a selection of a plurality of antenna ports from among the plurality of CDM groups based at least on antenna port indices. According to one or more embodiments of this aspect, the interleaving begins at the smallest index value of an antenna port index in each CDM group.

According to one or more embodiments of this aspect, the at least one DMRS parameter indicates a plurality of DMRS sequence initializations. The physical channel in the 2-step random access procedure is received according to a subset of the plurality of DMRS sequence initializations. According to one or more embodiments of this aspect, the subset of the plurality of DMRS sequence initializations is based on one of: a preamble of the 2-step random access procedure; an index of the preamble of the 2-step random access procedure; and an index of a PUSCH resource unit. According to one or more embodiments of this aspect, the receiving of the physical channel in the 2-step random access procedure corresponds to receiving a message A, msgA, in the PUSCH during the 2-step random access procedure.

According to another aspect of the disclosure, a method implemented by a wireless device that is configured to communicate with a network node is provided. An indication indicating at least one Demodulation Reference Signal, DMRS, parameter for a physical uplink shared channel, PUSCH in a 2-step random access procedure is received where the at least one DMRS parameter indicating a plurality of DMRS ports. A subset of the plurality of DMRS ports for the PUSCH in the 2-step random access procedure is determined.

According to one or more embodiments of this aspect, the determination of the subset of the plurality of DMRS ports is based on selecting a plurality of antenna ports from a plurality of code-division multiplexing, CDM, groups. According to one or more embodiments of this aspect, the determination of the subset of the plurality of DMRS ports includes: determining a first antenna port index of a first CDM group of the plurality of CDM groups that has a smallest index value among the first CDM group; selecting a first antenna port corresponding to the first antenna port index for inclusion in the subset of the plurality of DMRS ports; determining a second antenna port index of a second CDM group of the plurality of CDM groups that has a smallest index value among the second CDM group; and selecting a second antenna port corresponding to the second antenna port index for inclusion in the subset of the plurality of DMRS ports.

According to one or more embodiments of this aspect, the selection of the plurality of antenna ports includes: interleaving the selection of the plurality of antenna ports among the plurality of CDM groups based at least on an antenna port index in each CDM group. According to one or more embodiments of this aspect, the interleaving of the selection of the plurality of antenna ports begins at the smallest index value of an antenna port index in each CDM group. According to one or more embodiments of this aspect, the at least one DMRS parameter indicates a plurality of DMRS sequence initializations. A DMRS sequence initialization is selected from the plurality of DMRS sequence initialization for use with the subset of the plurality of DMRS ports.

According to one or more embodiments of this aspect, the selection of the DMRS sequence initialization is based on at least one of: a physical random access channel, PRACH, occasion for transmission of a preamble of the 2-step random access procedure; an index of the preamble of the 2-step random access procedure; and an index of a PUSCH resource unit. According to one or more embodiments of this aspect, transmission of a physical channel is caused in the 2-step random access procedure according to the determined subset of the plurality of DMRS ports. According to one or more embodiments of this aspect, the transmission of the physical channel in the 2-step random access procedure corresponds to transmission of a message A, msgA, in the PUSCH during the 2-step random access procedure.

According to another aspect of the disclosure, a method implemented by a network node that is configured to communicate with a wireless device is provided.

An indication indicating at least one Demodulation Reference Signal, DMRS, parameter for a physical uplink shared channel, PUSCH in a 2-step random access procedure is signaled where the at least one DMRS parameter indicates a plurality of DMRS ports. A physical channel in the 2-step random access procedure is received according to a subset of the plurality of DMRS ports for the PUSCH in the 2-step random access procedure.

According to one or more embodiments of this aspect, the subset of the plurality of DMRS ports is based on a plurality of code-division multiplexing, CDM, groups. According to one or more embodiments of this aspect, the subset of the plurality of DMRS ports is based on interleaving a selection of a plurality of antenna ports from among the plurality of CDM groups based at least on antenna port indices. According to one or more embodiments of this aspect, the interleaving begins at the smallest index value of an antenna port index in each CDM group.

According to one or more embodiments of this aspect, the at least one DMRS parameter indicates a plurality of DMRS sequence initializations. The physical channel in the 2-step random access procedure is received according to a subset of the plurality of DMRS sequence initializations. According to one or more embodiments of this aspect, the subset of the plurality of DMRS sequence initializations is based on one of: a preamble of the 2-step random access procedure; an index of the preamble of the 2-step random access procedure; and an index of a PUSCH resource unit. According to one or more embodiments of this aspect, the receiving of the physical channel in the 2-step random access procedure corresponds to receiving a message A, msgA, in the PUSCH during the 2-step random access procedure.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 illustrates an example of a four-step random access procedure;

FIG. 2 illustrates an example of a two-step random access procedure;

FIG. 3 illustrates an example of a single-symbol or double-symbol based DMRS;

FIG. 4 illustrates an example of a frequency mapping of DMRS;

FIG. 5 illustrates an example of a frequency mapping of DMRS;

FIG. 6 illustrates an example of a DMRS ports multiplexing;

FIG. 7 illustrates an example of a double-symbol, Type 1 DMRS ports multiplexing with both FD-OCC and TD-OCC;

FIG. 8 illustrates an example of a PUSCH and DMRS resource collision for 2 WDs in 2-step Random Access;

FIG. 9 is a schematic diagram of an exemplary network architecture illustrating a communication system connected via an intermediate network to a host computer according to the principles in the present disclosure;

FIG. 10 is a block diagram of a host computer communicating via a network node with a wireless device over an at least partially wireless connection according to some embodiments of the present disclosure;

FIG. 11 is a flowchart illustrating exemplary methods implemented in a communication system including a host computer, a network node and a wireless device for executing a client application at a wireless device according to some embodiments of the present disclosure;

FIG. 12 is a flowchart illustrating exemplary methods implemented in a communication system including a host computer, a network node and a wireless device for receiving user data at a wireless device according to some embodiments of the present disclosure;

FIG. 13 is a flowchart illustrating exemplary methods implemented in a communication system including a host computer, a network node and a wireless device for receiving user data from the wireless device at a host computer according to some embodiments of the present disclosure;

FIG. 14 is a flowchart illustrating exemplary methods implemented in a communication system including a host computer, a network node and a wireless device for receiving user data at a host computer according to some embodiments of the present disclosure;

FIG. 15 is a flowchart of an example process in a network node for a configuration unit according to some embodiments of the present disclosure;

FIG. 16 is a flowchart of another example process in a network node for a configuration unit according to some embodiments of the present disclosure;

FIG. 17 is a flowchart of an example process in a wireless device for a determination unit according to some embodiments of the present disclosure;

FIG. 18 is a flowchart of another example process in a wireless device for a determination unit according to some embodiments of the present disclosure;

FIG. 19 illustrates an example of a PUSCH occasion according to some embodiments of the present disclosure; and

FIG. 20 illustrates an example of a msgA PUSCH set including a set of PUSCH resource units according to some embodiments of the present disclosure.

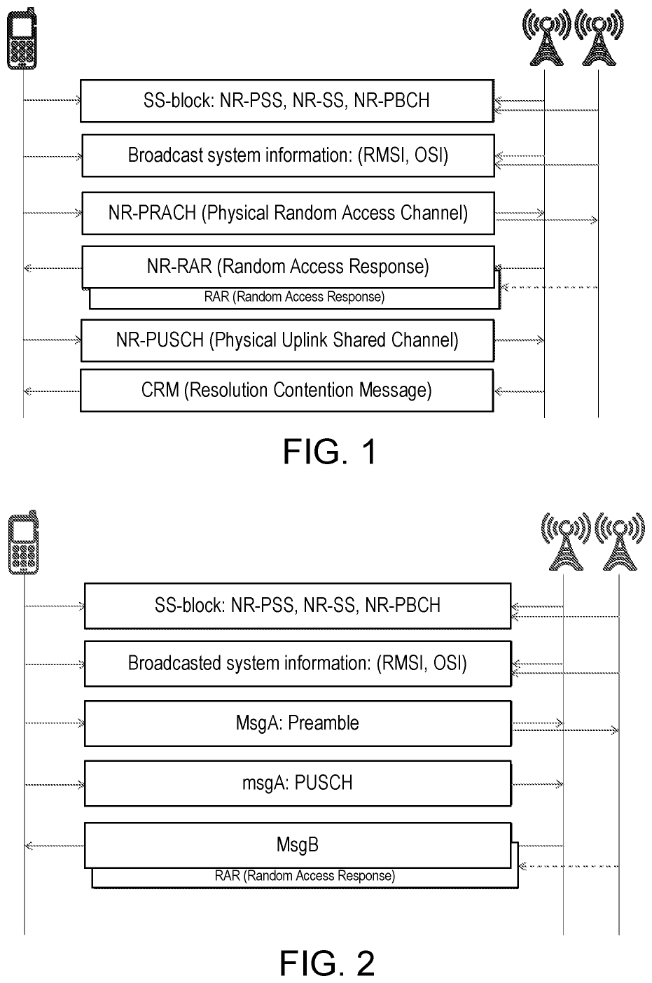

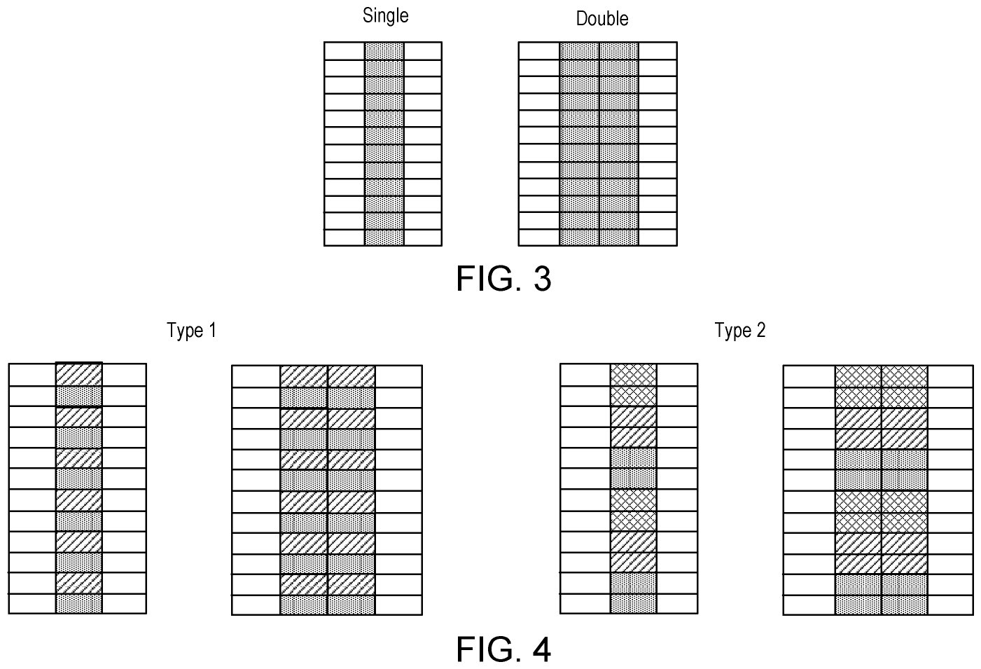

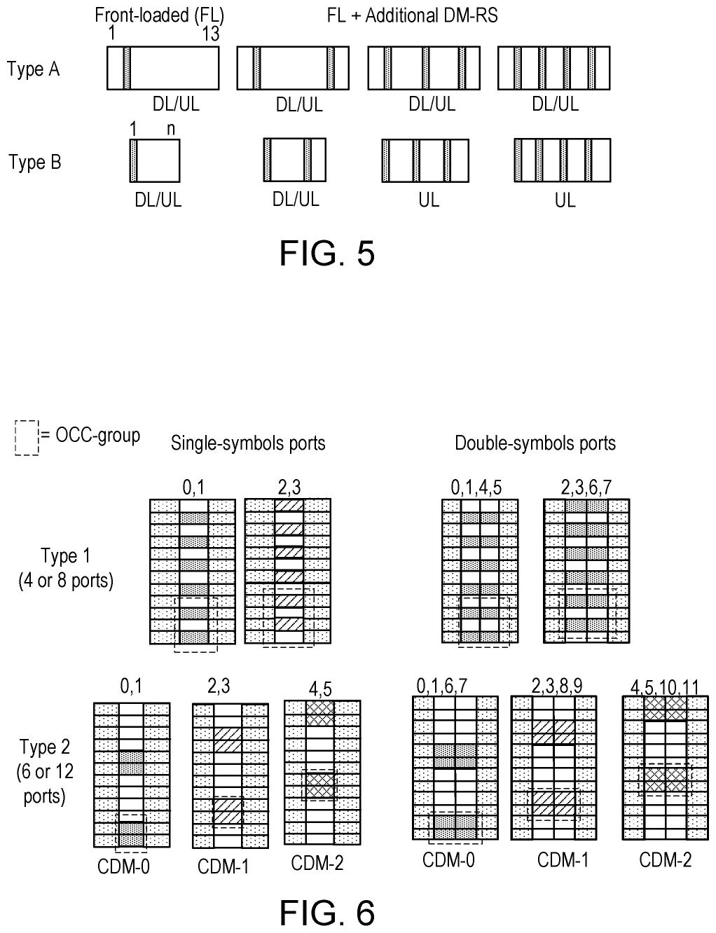

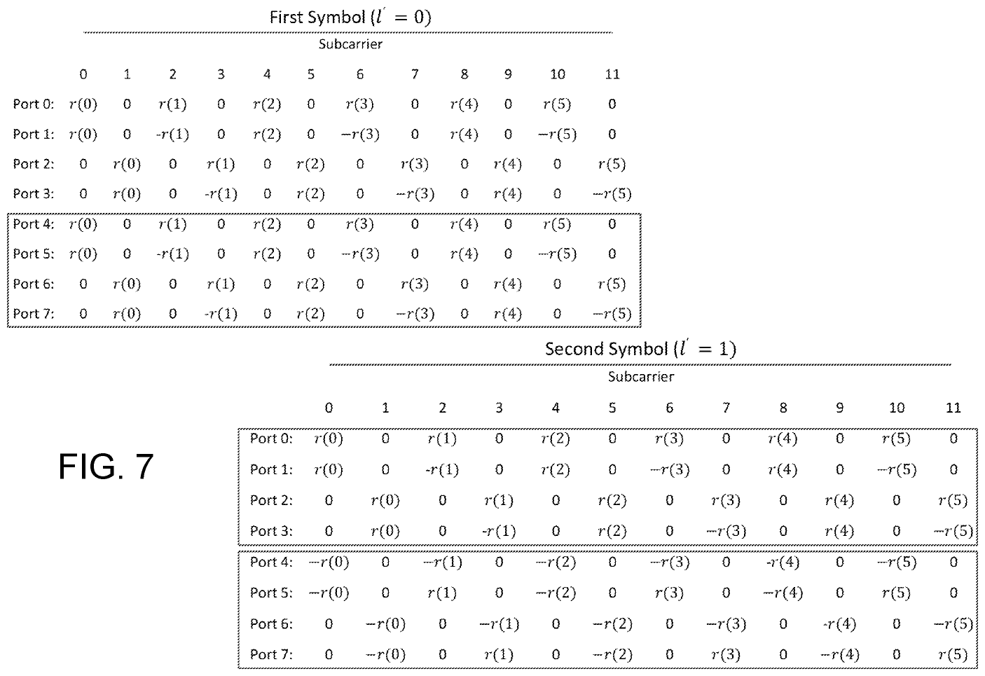

### DETAILED DESCRIPTION

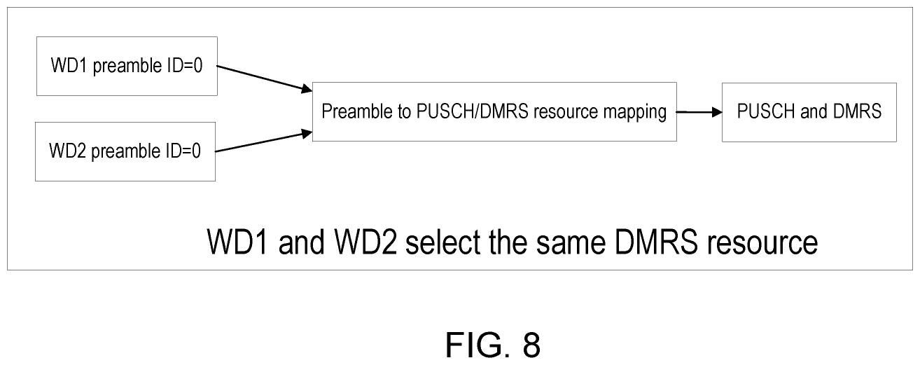

When introducing the new 2-step random access procedure, the PUSCH in msgA is transmitted in a PUSCH occasion following a PRACH preamble. Since different PUSCH resource units in a PUSCH occasion can have different DMRS parameters, mechanisms for determining the DMRS parameters for the PUSCH resource units should be designed. In particular, multiple WDs transmitting in a PUSCH occasion (PO) should use different DMRS to the extent possible to avoid the DMRS collision shown, for example, in FIG. 8. It is thus a problem how to define behavior and methods for DMRS of PUSCH carrying msgA for the 2-step random access.

3GPP Rel-15 NR indicates PUSCH DMRS ports and/or sequence initialization to each WD through DCI, or RRC signaling. This is generally not feasible for 2-step RACH contention based operation, where dynamically selected resources are determined by the WD. Therefore, techniques suitable for the WD to determine DMRS parameters for 2-step RACH are proposed herein.

Some embodiments are provided for a WD to determine DMRS parameters for a PUSCH that is transmitted in a random access procedure. In some embodiments, the DMRS can be generated using 3GPP NR Rel-15 mechanisms, except that the values used for DMRS sequence initialization may be set differently or, in the case of Discrete Fourier Transform-Spread-Orthogonal Frequency Division Multiplexing (DFT-S-OFDM), the sequence group may be determined differently.

In one set of embodiments, DMRS port subsets used for a PUSCH occasion are constructed from CDM groups of a DMRS configuration used for the PUSCH occasion. The subsets may be constructed by first including the first antenna port in each CDM group in the subset, then including the second antenna port in each CDM group in the subset, and so on until the subset includes the desired number of ports. Since each CDM group occupies a different set of subcarriers from the other CDM groups, selecting ports first from CDM groups enables low mutual interference among DMRS ports used for the PO.

In another set of embodiments, DMRS ports and/or sequence initialization is set by an index of a PRACH transmitted in association with the PUSCH. In one approach, the index of the preamble is added to a cell ID. In another approach, two modes are used to determine the antenna ports and sequence initialization, where a subset of antenna ports is constructed with only orthogonal ports in the first mode, and the subset contains antenna ports with different sequence initialization in the second mode.

In another set of embodiments, the DMRS and/or sequence initialization is determined as a function of an index of a PUSCH resource unit that comprises a modulo division by the number of ports or the number of sequence initializations mapped to the PUSCH occasion containing the PUSCH resource unit. The index or a function of the index may be modulo divided by the number of ports or the number of sequence initializations. Offsets to port number and/or sequence initialization may also be added in order to facilitate where PUSCH occasions with different sizes occupy some of the same PRBs.

Some of the embodiments may advantageously provide for a DMRS design for the PUSCH in msgA that can be specified for the 2-step random access procedure. Some embodiments may allow a larger number of unique DMRS (e.g., unique DMRS sequences) to be used within PUSCH occasions, thereby reducing the probability that any two WDs select the same DMRS and therefore improving msgA PUSCH reliability and capacity. Some embodiments may also reduce mutual interference among the DMRSs of different WDs by selecting particular DMRS ports with good mutual interference properties.

Before describing in detail exemplary embodiments, it is noted that the embodiments reside primarily in combinations of apparatus components and processing steps related to Physical Uplink Shared Channel (PUSCH) Demodulation Reference Signal (DMRS) design in a, e.g., 2-step random access. Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein. Like numbers refer to like elements throughout the description.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments described herein, the term “coupled,” “connected,” and the like, may be used herein to indicate a connection, although not necessarily directly, and may include wired and/or wireless connections.

The term “network node” used herein can be any kind of network node comprised in a radio network which may further comprise any of base station (BS), radio base station, base transceiver station (BTS), base station controller (BSC), radio network controller (RNC), g Node B (gNB), evolved Node B (eNB or eNodeB), Node B, multi-standard radio (MSR) radio node such as MSR BS, multi-cell/multicast coordination entity (MCE), integrated access and backhaul (IAB) node, relay node, donor node controlling relay, radio access point (AP), transmission points, transmission nodes, Remote Radio Unit (RRU) Remote Radio Head (RRH), a core network node (e.g., mobile management entity (MME), self-organizing network (SON) node, a coordinating node, positioning node, MDT node, etc.), an external node (e.g., 3rd party node, a node external to the current network), nodes in distributed antenna system (DAS), a spectrum access system (SAS) node, an element management system (EMS), etc. The network node may also comprise test equipment. The term “radio node” used herein may be used to also denote a wireless device (WD) such as a wireless device (WD) or a radio network node.

In some embodiments, the non-limiting terms wireless device (WD) or a user equipment (UE) are used interchangeably. The WD herein can be any type of wireless device capable of communicating with a network node or another WD over radio signals, such as wireless device (WD). The WD may also be a radio communication device, target device, device to device (D2D) WD, machine type WD or WD capable of machine to machine communication (M2M), low-cost and/or low-complexity WD, a sensor equipped with WD, Tablet, mobile terminals, smart phone, laptop embedded equipped (LEE), laptop mounted equipment (LME), USB dongles, Customer Premises Equipment (CPE), an Internet of Things (IoT) device, or a Narrowband IoT (NB-IOT) device, etc.

Also, in some embodiments the generic term “radio network node” is used. It can be any kind of a radio network node which may comprise any of base station, radio base station, base transceiver station, base station controller, network controller, RNC, evolved Node B (eNB), Node B, gNB, Multi-cell/multicast Coordination Entity (MCE), IAB node, relay node, access point, radio access point, Remote Radio Unit (RRU) Remote Radio Head (RRH).

Even though the descriptions herein may be explained in the context of one of a Downlink (DL) and an Uplink (UL) channel, it should be understood that the basic principles disclosed may also be applicable to the other of the one of the DL and the UL channel.

In some embodiments, a physical channel is a channel of a physical layer that transmits a modulation symbol obtained by modulating at least one coded bit stream. A transmitter and a receiver may previously agree on the rule for determining for which resources or resource elements (REs) the transmitter and receiver will arrange one physical channel (e.g., PUSCH) during transmission of the resources or REs, and this rule may be called ‘mapping’.

Any two or more embodiments described in this disclosure may be combined in any way with each other.

The term “signaling” used herein may comprise any of: high-layer signaling (e.g., via Radio Resource Control (RRC) or a like), lower-layer signaling (e.g., via a physical control channel or a broadcast channel), or a combination thereof. The signaling may be implicit or explicit. The signaling may further be unicast, multicast or broadcast. The signaling may also be directly to another node or via a third node.

Generally, it may be considered that the network, e.g., a signaling radio node and/or node arrangement (e.g., network node), configures a WD, in particular with the transmission resources, such as, physical uplink shared channel (PUSCH) resources. A resource may in general be configured with one or more messages. Different resources may be configured with different messages, and/or with messages on different layers or layer combinations. The size of a resource may be represented in symbols and/or subcarriers and/or resource elements and/or physical resource blocks (depending on domain), and/or in number of bits it may carry, e.g., information or payload bits, or total number of bits. The set of resources, and/or the resources of the sets, may pertain to the same carrier and/or bandwidth part, and/or may be located in the same slot, or in neighboring slots.

It may be considered that receiving signaling comprises demodulating and/or decoding and/or detecting, e.g., blind detection of, one or more messages, in particular a message carried by the signaling, e.g., based on an assumed set of resources (e.g., set of PUSCH resources), which may be searched and/or listened for the control information. It may be assumed that both sides of the communication are aware of the configurations, and may determine the set of resources, according to one or more of the techniques disclosed herein.

Signaling may generally comprise one or more symbols and/or signals and/or messages. A signal may comprise or represent one or more bits. An indication may represent signaling, and/or be implemented as a signal, or as a plurality of signals. One or more signals may be included in and/or represented by a message. Signaling may comprise a plurality of signals and/or messages, which may be transmitted on different carriers and/or be associated to different signaling processes, e.g., representing and/or pertaining to one or more such processes and/or corresponding information. An indication may comprise signaling, and/or a plurality of signals and/or messages and/or may be comprised therein, which may be transmitted on different carriers and/or be associated to different acknowledgement signaling processes, e.g., representing and/or pertaining to one or more such processes. Signaling associated to a channel (e.g., physical random access channel (PRACH)) may be transmitted such that represents signaling and/or information for that channel, and/or that the signaling is interpreted by the transmitter and/or receiver to belong to that channel. Such signaling may generally comply with transmission parameters and/or format/s for the channel.

An indication (e.g., an indication of one or more DMRS parameters for a random access procedure, etc.) generally may explicitly and/or implicitly indicate the information it represents and/or indicates. Implicit indication may for example be based on position and/or resource used for transmission. Explicit indication may for example be based on a parametrization with one or more parameters, and/or one or more index or indices corresponding to a table, and/or one or more bit patterns representing the information.

Configuring a radio node, in particular a terminal or WD, may refer to the radio node being adapted or caused or set and/or instructed to operate according to the configuration (e.g., PUSCH configuration). Configuring may be done by another device, e.g., a network node (e.g., network node) (for example, a base station or gNB) or network, in which case it may comprise transmitting configuration data to the radio node to be configured. Such configuration data may represent the configuration to be configured and/or comprise one or more instruction pertaining to a configuration, e.g., a configuration for transmitting and/or receiving on allocated resources, in particular frequency resources. A radio node may configure itself, e.g., based on configuration data received from a network or network node. A network node may utilize, and/or be adapted to utilize, its circuitry/ies for configuring. Allocation information may be considered a form of configuration data. Configuration data may comprise and/or be represented by configuration information, and/or one or more corresponding indications and/or message/s.

A channel may generally be a logical, transport or physical channel. A channel may comprise and/or be arranged on one or more carriers, in particular a plurality of subcarriers. A channel carrying and/or for carrying control signaling/control information may be considered a control channel, in particular if it is a physical layer channel and/or if it carries control plane information. Analogously, a channel carrying and/or for carrying data signaling/user information may be considered a data channel, in particular if it is a physical layer channel and/or if it carries user plane information. A channel may be defined for a specific communication direction, or for two complementary communication directions (e.g., UL and DL, or sidelink in two directions), in which case it may be considered to have at least two component channels, one for each direction. In some embodiments, the channel described herein may be an uplink channel and in further embodiments may be a physical uplink shared channel (PUSCH) and in yet further embodiments may be a PUSCH associated with a 2-step random access procedure.

Generally, configuring may include determining configuration data representing the configuration and providing, e.g., transmitting, it to one or more other nodes (parallel and/or sequentially), which may transmit it further to the radio node (or another node, which may be repeated until it reaches the wireless device). Alternatively, or additionally, configuring a radio node, e.g., by a network node or other device, may include receiving configuration data and/or data pertaining to configuration data, e.g., from another node like a network node, which may be a higher-level node of the network, and/or transmitting received configuration data to the radio node. Accordingly, determining a configuration and transmitting the configuration data to the radio node may be performed by different network nodes or entities, which may be able to communicate via a suitable interface, e.g., an X2 interface in the case of LTE or a corresponding interface for NR. Configuring a terminal (e.g., WD) may comprise scheduling downlink and/or uplink transmissions for the terminal, e.g., downlink data and/or downlink control signaling and/or DCI and/or uplink control or data or communication signaling, in particular acknowledgement signaling, and/or configuring resources and/or a resource pool therefor. In particular, configuring a terminal (e.g., WD) may comprise configuring the WD to transmit PUSCH according to one or more DMRS parameters.

Note that although terminology from one particular wireless system, such as, for example, 3GPP LTE and/or New Radio (NR), may be used in this disclosure, this should not be seen as limiting the scope of the disclosure to only the aforementioned system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from exploiting the ideas covered within this disclosure.

Note further, that functions described herein as being performed by a wireless device or a network node may be distributed over a plurality of wireless devices and/or network nodes. In other words, it is contemplated that the functions of the network node and wireless device described herein are not limited to performance by a single physical device and, in fact, can be distributed among several physical devices.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

Some embodiments provide for a Physical Uplink Shared Channel (PUSCH) Demodulation Reference Signal (DMRS) design in a, e.g., 2-step random access.

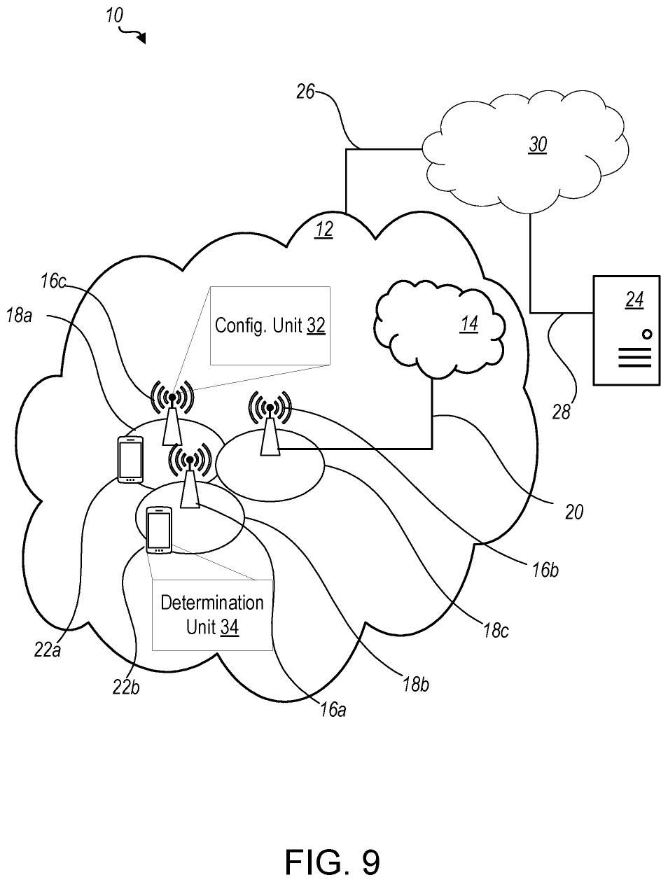

Referring again to the drawing figures, in which like elements are referred to by like reference numerals, there is shown in FIG. 9 a schematic diagram of a communication system 10, according to an embodiment, such as a 3GPP-type cellular network that may support standards such as LTE and/or NR (5G), which comprises an access network 12, such as a radio access network, and a core network 14. The access network 12 comprises a plurality of network nodes 16a, 16b, 6c (referred to collectively as network nodes 16), such as NBs, eNBs, gNBs or other types of wireless access points, each defining a corresponding coverage area 18a, 18b, 18c (referred to collectively as coverage areas 18). Each network node 16a, 16b, 16c is connectable to the core network 14 over a wired or wireless connection 20. A first wireless device (WD) 22a located in coverage area 18 a is configured to wirelessly connect to, or be paged by, the corresponding network node 16c. A second WD 22b in coverage area 18b is wirelessly connectable to the corresponding network node 16a. While a plurality of WDs 22a, 22b (collectively referred to as wireless devices 22) are illustrated in this example, the disclosed embodiments are equally applicable to a situation where a sole WD is in the coverage area or where a sole WD is connecting to the corresponding network node 16. Note that although only two WDs 22 and three network nodes 16 are shown for convenience, the communication system may include many more WDs 22 and network nodes 16.

Also, it is contemplated that a WD 22 can be in simultaneous communication and/or configured to separately communicate with more than one network node 16 and more than one type of network node 16. For example, a WD 22 can have dual connectivity with a network node 16 that supports LTE and the same or a different network node 16 that supports NR. As an example, WD 22 can be in communication with an eNB for LTE/E-UTRAN and a gNB for NR/NG-RAN.

The communication system 10 may itself be connected to a host computer 24, which may be embodied in the hardware and/or software of a standalone server, a cloud-implemented server, a distributed server or as processing resources in a server farm. The host computer 24 may be under the ownership or control of a service provider, or may be operated by the service provider or on behalf of the service provider. The connections 26, 28 between the communication system 10 and the host computer 24 may extend directly from the core network 14 to the host computer 24 or may extend via an optional intermediate network 30. The intermediate network 30 may be one of, or a combination of more than one of, a public, private or hosted network. The intermediate network 30, if any, may be a backbone network or the Internet. In some embodiments, the intermediate network 30 may comprise two or more sub-networks (not shown).

The communication system of FIG. 9 as a whole enables connectivity between one of the connected WDs 22a, 22b and the host computer 24. The connectivity may be described as an over-the-top (OTT) connection. The host computer 24 and the connected WDs 22a, 22b are configured to communicate data and/or signaling via the OTT connection, using the access network 12, the core network 14, any intermediate network 30 and possible further infrastructure (not shown) as intermediaries. The OTT connection may be transparent in the sense that at least some of the participating communication devices through which the OTT connection passes are unaware of routing of uplink and downlink communications. For example, a network node 16 may not or need not be informed about the past routing of an incoming downlink communication with data originating from a host computer 24 to be forwarded (e.g., handed over) to a connected WD 22a. Similarly, the network node 16 need not be aware of the future routing of an outgoing uplink communication originating from the WD 22a towards the host computer 24.

A network node 16 is configured to include a configuration unit 32 which is configured to signal an indication of at least one Demodulation Reference Signal (DMRS) parameter for a 2-step random access procedure; and receive a physical channel in the 2-step random access procedure according to the at least one DMRS parameter.

A wireless device 22 is configured to include a determination unit 34 which is configured to determine at least one Demodulation Reference Signal (DMRS) parameter for a 2-step random access procedure; and transmit a physical channel in the 2-step random access procedure according to the determined at least one DMRS parameter.

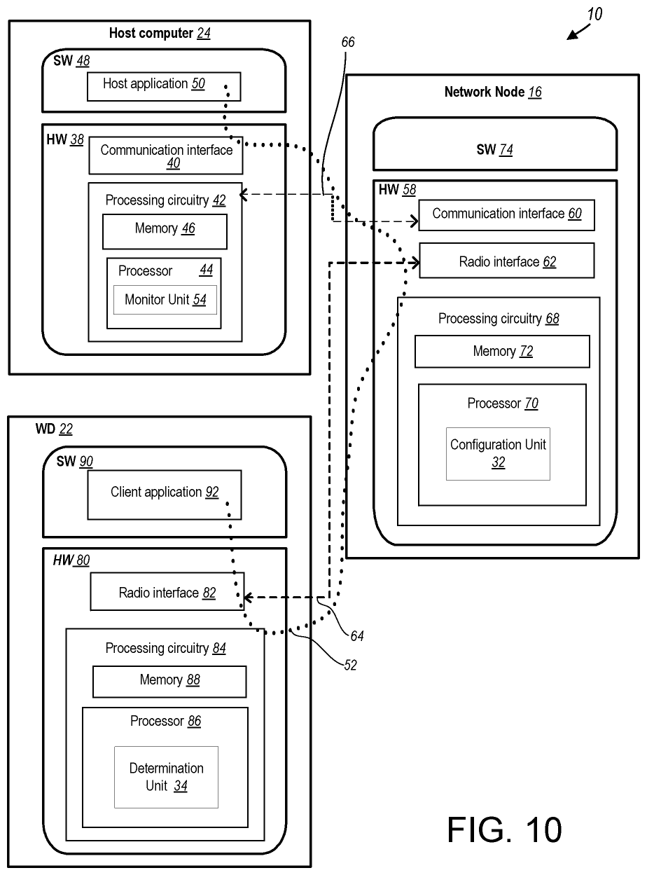

Example implementations, in accordance with an embodiment, of the WD 22, network node 16 and host computer 24 discussed in the preceding paragraphs will now be described with reference to FIG. 10. In a communication system 10, a host computer 24 comprises hardware (HW) 38 including a communication interface 40 configured to set up and maintain a wired or wireless connection with an interface of a different communication device of the communication system 10. The host computer 24 further comprises processing circuitry 42, which may have storage and/or processing capabilities. The processing circuitry 42 may include a processor 44 and memory 46. In particular, in addition to or instead of a processor, such as a central processing unit, and memory, the processing circuitry 42 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 44 may be configured to access (e.g., write to and/or read from) memory 46, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Processing circuitry 42 may be configured to control any of the methods and/or processes described herein and/or to cause such methods, and/or processes to be performed, e.g., by host computer 24. Processor 44 corresponds to one or more processors 44 for performing host computer 24 functions described herein. The host computer 24 includes memory 46 that is configured to store data, programmatic software code and/or other information described herein. In some embodiments, the software 48 and/or the host application 50 may include instructions that, when executed by the processor 44 and/or processing circuitry 42, causes the processor 44 and/or processing circuitry 42 to perform the processes described herein with respect to host computer 24. The instructions may be software associated with the host computer 24.

The software 48 may be executable by the processing circuitry 42. The software 48 includes a host application 50. The host application 50 may be operable to provide a service to a remote user, such as a WD 22 connecting via an OTT connection 52 terminating at the WD 22 and the host computer 24. In providing the service to the remote user, the host application 50 may provide user data which is transmitted using the OTT connection 52. The “user data” may be data and information described herein as implementing the described functionality. In one embodiment, the host computer 24 may be configured for providing control and functionality to a service provider and may be operated by the service provider or on behalf of the service provider. The processing circuitry 42 of the host computer 24 may enable the host computer 24 to observe, monitor, control, transmit to and/or receive from the network node 16 and/or the wireless device 22. The processing circuitry 42 of the host computer 24 may include a monitor unit 54 configured to enable the service provider to observe, monitor, control, transmit to and/or receive from the network node 16 and/or the wireless device 22.

The communication system 10 further includes a network node 16 provided in a communication system 10 and including hardware 58 enabling it to communicate with the host computer 24 and with the WD 22. The hardware 58 may include a communication interface 60 for setting up and maintaining a wired or wireless connection with an interface of a different communication device of the communication system 10, as well as a radio interface 62 for setting up and maintaining at least a wireless connection 64 with a WD 22 located in a coverage area 18 served by the network node 16. The radio interface 62 may be formed as or may include, for example, one or more RF transmitters, one or more RF receivers, and/or one or more RF transceivers. The communication interface 60 may be configured to facilitate a connection 66 to the host computer 24. The connection 66 may be direct or it may pass through a core network 14 of the communication system 10 and/or through one or more intermediate networks 30 outside the communication system 10.

In the embodiment shown, the hardware 58 of the network node 16 further includes processing circuitry 68. The processing circuitry 68 may include a processor 70 and a memory 72. In particular, in addition to or instead of a processor, such as a central processing unit, and memory, the processing circuitry 68 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 70 may be configured to access (e.g., write to and/or read from) the memory 72, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

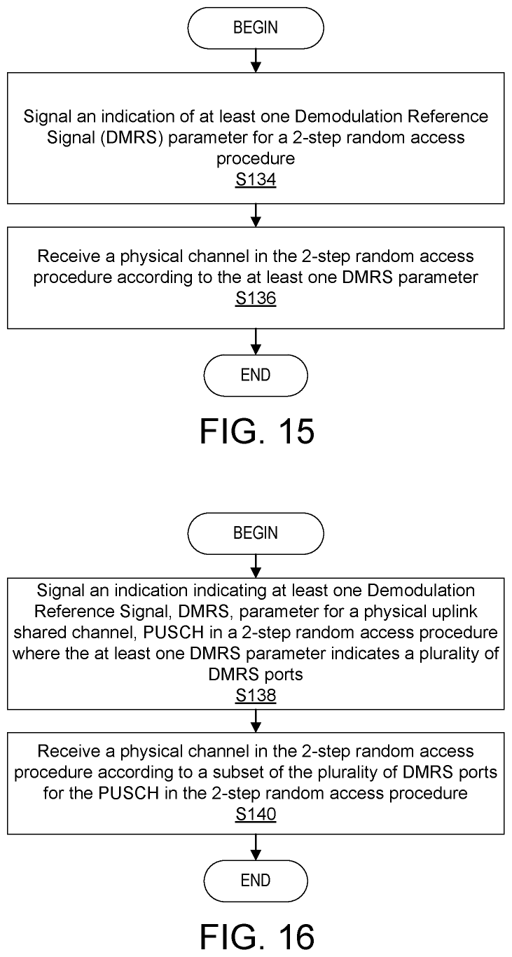

Thus, the network node 16 further has software 74 stored internally in, for example, memory 72, or stored in external memory (e.g., database, storage array, network storage device, etc.) accessible by the network node 16 via an external connection. The software 74 may be executable by the processing circuitry 68. The processing circuitry 68 may be configured to control any of the methods and/or processes described herein and/or to cause such methods, and/or processes to be performed, e.g., by network node 16. Processor 70 corresponds to one or more processors 70 for performing network node 16 functions described herein. The memory 72 is configured to store data, programmatic software code and/or other information described herein. In some embodiments, the software 74 may include instructions that, when executed by the processor 70 and/or processing circuitry 68, causes the processor 70 and/or processing circuitry 68 to perform the processes described herein with respect to network node 16. For example, processing circuitry 68 of the network node 16 may include configuration unit 32 configured to perform the network node methods discussed herein, such as, for example, as discussed with reference to the flowchart in FIG. 15.

The communication system 10 further includes the WD 22 already referred to. The WD 22 may have hardware 80 that may include a radio interface 82 configured to set up and maintain a wireless connection 64 with a network node 16 serving a coverage area 18 in which the WD 22 is currently located. The radio interface 82 may be formed as or may include, for example, one or more RF transmitters, one or more RF receivers, and/or one or more RF transceivers.

The hardware 80 of the WD 22 further includes processing circuitry 84. The processing circuitry 84 may include a processor 86 and memory 88. In particular, in addition to or instead of a processor, such as a central processing unit, and memory, the processing circuitry 84 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 86 may be configured to access (e.g., write to and/or read from) memory 88, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the WD 22 may further comprise software 90, which is stored in, for example, memory 88 at the WD 22, or stored in external memory (e.g., database, storage array, network storage device, etc.) accessible by the WD 22. The software 90 may be executable by the processing circuitry 84. The software 90 may include a client application 92. The client application 92 may be operable to provide a service to a human or non-human user via the WD 22, with the support of the host computer 24. In the host computer 24, an executing host application 50 may communicate with the executing client application 92 via the OTT connection 52 terminating at the WD 22 and the host computer 24. In providing the service to the user, the client application 92 may receive request data from the host application 50 and provide user data in response to the request data. The OTT connection 52 may transfer both the request data and the user data. The client application 92 may interact with the user to generate the user data that it provides.

The processing circuitry 84 may be configured to control any of the methods and/or processes described herein and/or to cause such methods, and/or processes to be performed, e.g., by WD 22. The processor 86 corresponds to one or more processors 86 for performing WD 22 functions described herein. The WD 22 includes memory 88 that is configured to store data, programmatic software code and/or other information described herein. In some embodiments, the software 90 and/or the client application 92 may include instructions that, when executed by the processor 86 and/or processing circuitry 84, causes the processor 86 and/or processing circuitry 84 to perform the processes described herein with respect to WD 22. For example, the processing circuitry 84 of the wireless device 22 may include a determination unit 34 configured to perform the WD methods discussed herein, such as, for example, as discussed with reference to the flowchart in FIG. 16.

In some embodiments, the inner workings of the network node 16, WD 22, and host computer 24 may be as shown in FIG. 10 and independently, the surrounding network topology may be that of FIG. 9.

In FIG. 10, the OTT connection 52 has been drawn abstractly to illustrate the communication between the host computer 24 and the wireless device 22 via the network node 16, without explicit reference to any intermediary devices and the precise routing of messages via these devices. Network infrastructure may determine the routing, which it may be configured to hide from the WD 22 or from the service provider operating the host computer 24, or both. While the OTT connection 52 is active, the network infrastructure may further take decisions by which it dynamically changes the routing (e.g., on the basis of load balancing consideration or reconfiguration of the network).

The wireless connection 64 between the WD 22 and the network node 16 is in accordance with the teachings of the embodiments described throughout this disclosure. One or more of the various embodiments improve the performance of OTT services provided to the WD 22 using the OTT connection 52, in which the wireless connection 64 may form the last segment. More precisely, the teachings of some of these embodiments may improve the data rate, latency, and/or power consumption and thereby provide benefits such as reduced user waiting time, relaxed restriction on file size, better responsiveness, extended battery lifetime, etc.

In some embodiments, a measurement procedure may be provided for the purpose of monitoring data rate, latency and other factors on which the one or more embodiments improve. There may further be an optional network functionality for reconfiguring the OTT connection 52 between the host computer 24 and WD 22, in response to variations in the measurement results. The measurement procedure and/or the network functionality for reconfiguring the OTT connection 52 may be implemented in the software 48 of the host computer 24 or in the software 90 of the WD 22, or both. In embodiments, sensors (not shown) may be deployed in or in association with communication devices through which the OTT connection 52 passes; the sensors may participate in the measurement procedure by supplying values of the monitored quantities exemplified above, or supplying values of other physical quantities from which software 48, 90 may compute or estimate the monitored quantities. The reconfiguring of the OTT connection 52 may include message format, retransmission settings, preferred routing etc.; the reconfiguring need not affect the network node 16, and it may be unknown or imperceptible to the network node 16. Some such procedures and functionalities may be known and practiced in the art. In certain embodiments, measurements may involve proprietary WD signaling facilitating the host computer's 24 measurements of throughput, propagation times, latency and the like. In some embodiments, the measurements may be implemented in that the software 48, 90 causes messages to be transmitted, in particular empty or ‘dummy’ messages, using the OTT connection 52 while it monitors propagation times, errors, etc.

Thus, in some embodiments, the host computer 24 includes processing circuitry 42 configured to provide user data and a communication interface 40 that is configured to forward the user data to a cellular network for transmission to the WD 22. In some embodiments, the cellular network also includes the network node 16 with a radio interface 62. In some embodiments, the network node 16 is configured to, and/or the network node's 16 processing circuitry 68 is configured to perform the functions and/or methods described herein for preparing/initiating/maintaining/supporting/ending a transmission to the WD 22, and/or preparing/terminating/maintaining/supporting/ending in receipt of a transmission from the WD 22.

In some embodiments, the host computer 24 includes processing circuitry 42 and a communication interface 40 that is configured to a communication interface 40 configured to receive user data originating from a transmission from a WD 22 to a network node 16. In some embodiments, the WD 22 is configured to, and/or comprises a radio interface 82 and/or processing circuitry 84 configured to perform the functions and/or methods described herein for preparing/initiating/maintaining/supporting/ending a transmission to the network node 16, and/or preparing/terminating/maintaining/supporting/ending in receipt of a transmission from the network node 16.

Although FIGS. 9 and 10 show various “units” such as configuration unit 32, and determination unit 34 as being within a respective processor, it is contemplated that these units may be implemented such that a portion of the unit is stored in a corresponding memory within the processing circuitry. In other words, the units may be implemented in hardware or in a combination of hardware and software within the processing circuitry.

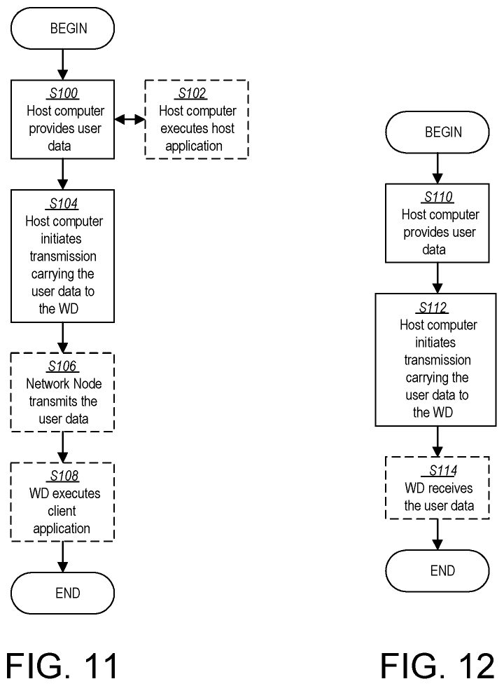

FIG. 11 is a flowchart illustrating an exemplary method implemented in a communication system, such as, for example, the communication system of FIGS. 9 and 10, in accordance with one embodiment. The communication system may include a host computer 24, a network node 16 and a WD 22, which may be those described with reference to FIG. 10. In a first step of the method, the host computer 24 provides user data (Block S100). In an optional substep of the first step, the host computer 24 provides the user data by executing a host application, such as, for example, the host application 50 (Block S102). In a second step, the host computer 24 initiates a transmission carrying the user data to the WD 22 (Block S104). In an optional third step, the network node 16 transmits to the WD 22 the user data which was carried in the transmission that the host computer 24 initiated, in accordance with the teachings of the embodiments described throughout this disclosure (Block S106). In an optional fourth step, the WD 22 executes a client application, such as, for example, the client application 92, associated with the host application 50 executed by the host computer 24 (Block S108).

FIG. 12 is a flowchart illustrating an exemplary method implemented in a communication system, such as, for example, the communication system of FIG. 9, in accordance with one embodiment. The communication system may include a host computer 24, a network node 16 and a WD 22, which may be those described with reference to FIGS. 9 and 10. In a first step of the method, the host computer 24 provides user data (Block S110). In an optional substep (not shown) the host computer 24 provides the user data by executing a host application, such as, for example, the host application 50. In a second step, the host computer 24 initiates a transmission carrying the user data to the WD 22 (Block S112). The transmission may pass via the network node 16, in accordance with the teachings of the embodiments described throughout this disclosure. In an optional third step, the WD 22 receives the user data carried in the transmission (Block S114).

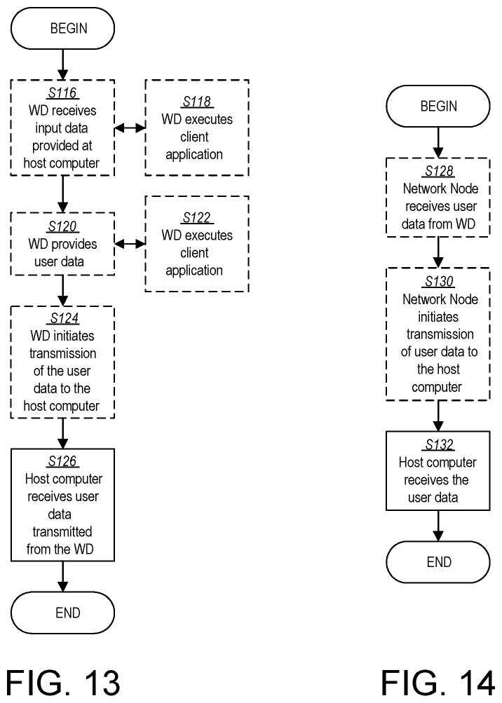

FIG. 13 is a flowchart illustrating an exemplary method implemented in a communication system, such as, for example, the communication system of FIG. 9, in accordance with one embodiment. The communication system may include a host computer 24, a network node 16 and a WD 22, which may be those described with reference to FIGS. 9 and 10. In an optional first step of the method, the WD 22 receives input data provided by the host computer 24 (Block S116). In an optional substep of the first step, the WD 22 executes the client application 92, which provides the user data in reaction to the received input data provided by the host computer 24 (Block S118). Additionally or alternatively, in an optional second step, the WD 22 provides user data (Block S120). In an optional substep of the second step, the WD provides the user data by executing a client application, such as, for example, client application 92 (Block S122). In providing the user data, the executed client application 92 may further consider user input received from the user. Regardless of the specific manner in which the user data was provided, the WD 22 may initiate, in an optional third substep, transmission of the user data to the host computer 24 (Block S124). In a fourth step of the method, the host computer 24 receives the user data transmitted from the WD 22, in accordance with the teachings of the embodiments described throughout this disclosure (Block S126).

FIG. 14 is a flowchart illustrating an exemplary method implemented in a communication system, such as, for example, the communication system of FIG. 9, in accordance with one embodiment. The communication system may include a host computer 24, a network node 16 and a WD 22, which may be those described with reference to FIGS. 9 and 10. In an optional first step of the method, in accordance with the teachings of the embodiments described throughout this disclosure, the network node 16 receives user data from the WD 22 (Block S128). In an optional second step, the network node 16 initiates transmission of the received user data to the host computer 24 (Block S130). In a third step, the host computer 24 receives the user data carried in the transmission initiated by the network node 16 (Block S132).

FIG. 15 is a flowchart of an example process in a network node 16 for DMRS design according to some embodiments of the present disclosure. One or more Blocks and/or functions and/or methods performed by the network node 16 may be performed by one or more elements of network node 16 such as by configuration unit 32 in processing circuitry 68, processor 70, radio interface 62, etc. according to the example method. The example method includes signaling (Block S134), such as via configuration unit 32, processing circuitry 68, processor 70 and/or radio interface 62, an indication of at least one Demodulation Reference Signal (DMRS) parameter for a 2-step random access procedure. The method includes receiving (Block S136), such as via configuration unit 32, processing circuitry 68, processor 70 and/or radio interface 62, a physical channel in the 2-step random access procedure according to the at least one DMRS parameter.

In some embodiments, the at least one DMRS parameter is indicated, such as via configuration unit 32, processing circuitry 68, processor 70 and/or radio interface 62, in a physical uplink shared channel (PUSCH) configuration. In some embodiments, the at least one DMRS parameter is indicated based at least in part on a preamble-to-PUSCH resource unit mapping. In some embodiments, the at least one DMRS parameter is indicated based at least in part on a fixed parameter. In some embodiments, the at least one DMRS parameter is indicated, such as via configuration unit 32, processing circuitry 68, processor 70 and/or radio interface 62, based at least in part on a pre-defined expression.

In some embodiments, the at least one DMRS parameter includes one or more parameters defining a msgA PUSCH set. In some embodiments, the at least one DMRS parameter is associated with a preamble used for the random access procedure. In some embodiments, the at least one DMRS parameter includes a DMRS port and/or a DMRS port subset. In some embodiments, the at least one DMRS parameter includes a DMRS sequence initialization. In some embodiments, the at least one DMRS parameter includes orthogonal frequency division multiplexing (OFDM) symbols to be used for physical uplink shared channel (PUSCH). In some embodiments, the at least one DMRS parameter is associated with a code division multiplexing (CDM) grouping of a DMRS configuration used for a physical uplink shared channel (PUSCH) occasion. In some embodiments, the at least one DMRS parameter is associated with a mode used to determine DMRS antenna port and sequence initialization.

FIG. 16 is a flowchart of another example process in a network node 16 for DMRS design according to some embodiments of the present disclosure. One or more Blocks and/or functions and/or methods performed by the network node 16 may be performed by one or more elements of network node 16 such as by configuration unit 32 in processing circuitry 68, processor 70, radio interface 62, etc. according to the example method. The example method includes signaling (Block S138), such as via configuration unit 32, processing circuitry 68, processor 70 and/or radio interface 62, an indication indicating at least one Demodulation Reference Signal, DMRS, parameter for a physical uplink shared channel, PUSCH in a 2-step random access procedure, the at least one DMRS parameter indicating a plurality of DMRS ports. The method includes receiving (Block S140), such as via configuration unit 32, processing circuitry 68, processor 70 and/or radio interface 62, a physical channel in the 2-step random access procedure according to a subset of the plurality of DMRS ports for the PUSCH in the 2-step random access procedure.

In some embodiments, the network node 16 may use the determined DMRS port/sequence to perform the channel estimation when receiving the MsgA PUSCH. In some embodiments, the subset of the plurality of DMRS ports is based on a plurality of code-division multiplexing, CDM, groups. In some embodiments, the subset of the plurality of DMRS ports is based on interleaving a selection of a plurality of antenna ports from among the plurality of CDM groups based at least on antenna port indices. In some embodiments, the interleaving begins at the smallest index value of an antenna port index in each CDM group.

In some embodiments, the at least one DMRS parameter indicates a plurality of DMRS sequence initializations, where the physical channel in the 2-step random access procedure is received according to a subset of the plurality of DMRS sequence initializations. In some embodiments, the subset of the plurality of DMRS sequence initializations is based on one of: a preamble of the 2-step random access procedure; an index of the preamble of the 2-step random access procedure; and an index of a PUSCH resource unit. In some embodiments, the receiving of the physical channel in the 2-step random access procedure corresponds to receiving a message A, msgA, in the PUSCH during the 2-step random access procedure.

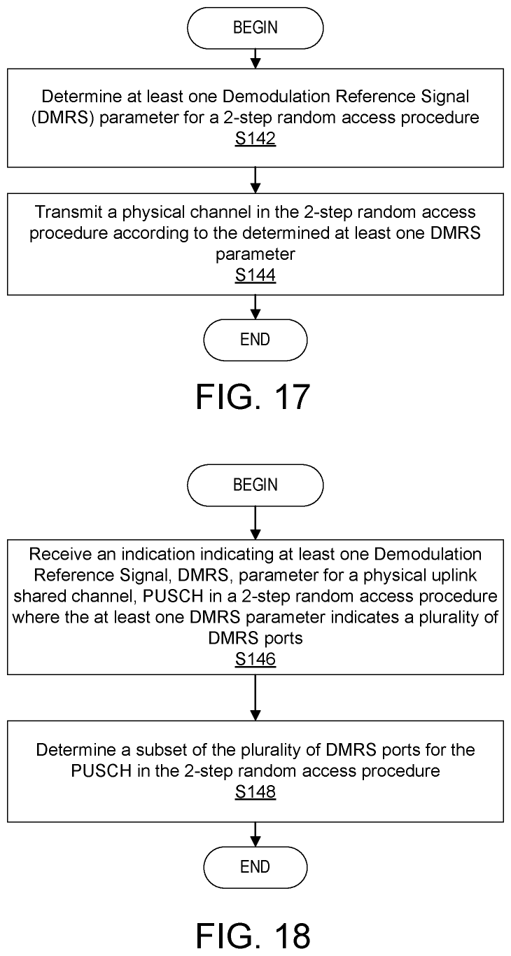

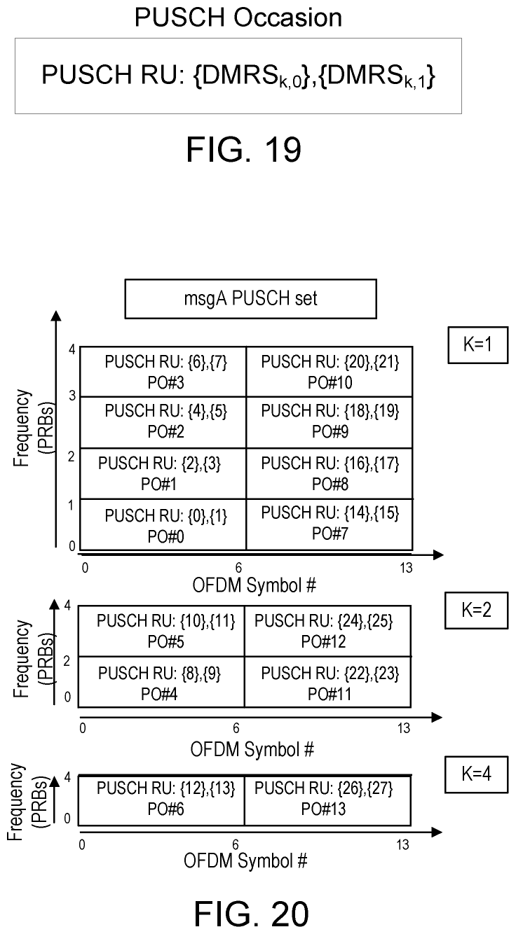

FIG. 17 is a flowchart of an example process in a wireless device 22 for DMRS design according to some embodiments of the present disclosure. One or more Blocks and/or functions and/or methods performed by WD 22 may be performed by one or more elements of WD 22 such as by determiner unit 34 in processing circuitry 84, processor 86, radio interface 82, etc. The example method includes determining (Block S142), such as via determiner unit 34, processing circuitry 84, processor 86 and/or radio interface 82, at least one Demodulation Reference Signal (DMRS) parameter for a 2-step random access procedure. The method includes transmitting (Block S144), such as via determiner unit 34, processing circuitry 84, processor 86 and/or radio interface 82, a physical channel in the 2-step random access procedure according to the determined at least one DMRS parameter.

In some embodiments, determining the at least one DMRS parameter further comprises determining, such as via determiner unit 34, processing circuitry 84, processor 86 and/or radio interface 82, the at least one DMRS parameter according to a physical uplink shared channel (PUSCH) configuration received from the network node 16. In some embodiments, determining the at least one DMRS parameter further comprises determining, such as via determiner unit 34, processing circuitry 84, processor 86 and/or radio interface 82, the at least one DMRS parameter according to a preamble-to-PUSCH resource unit mapping. In some embodiments, determining the at least one DMRS parameter further comprises determining, such as via determiner unit 34, processing circuitry 84, processor 86 and/or radio interface 82, the at least one DMRS parameter according to a fixed parameter. In some embodiments, determining the at least one DMRS parameter further comprises determining, such as via determiner unit 34, processing circuitry 84, processor 86 and/or radio interface 82, the at least one DMRS parameter according to a pre-defined expression.

In some embodiments, the at least one DMRS parameter includes one or more parameters defining a msgA PUSCH set. In some embodiments, the at least one DMRS parameter is determined, such as via determiner unit 34, processing circuitry 84, processor 86 and/or radio interface 82, according to a selected preamble for the random access procedure. In some embodiments, the at least one DMRS parameter includes a DMRS port and/or a DMRS port subset. In some embodiments, the at least one DMRS parameter includes a DMRS sequence initialization. In some embodiments, the at least one DMRS parameter includes orthogonal frequency division multiplexing (OFDM) symbols to be used for physical uplink shared channel (PUSCH). In some embodiments, the at least one DMRS parameter is determined, such as via determiner unit 34, processing circuitry 84, processor 86 and/or radio interface 82, according to a code division multiplexing (CDM) grouping of a DMRS configuration used for a physical uplink shared channel (PUSCH) occasion. In some embodiments, the at least one DMRS parameter is determined, such as via determiner unit 34, processing circuitry 84, processor 86 and/or radio interface 82, according to a mode used to determine DMRS antenna port and sequence initialization. In some embodiments, the network node 16 may use the determined DMRS port/sequence to perform the channel estimation when receiving the MsgA PUSCH.

FIG. 18 is a flowchart of an example process in a wireless device 22 for DMRS design according to some embodiments of the present disclosure. One or more Blocks and/or functions and/or methods performed by WD 22 may be performed by one or more elements of WD 22 such as by determiner unit 34 in processing circuitry 84, processor 86, radio interface 82, etc. The example method includes receiving (Block S146), such as via determiner unit 34, processing circuitry 84, processor 86 and/or radio interface 82, an indication indicating at least one Demodulation Reference Signal, DMRS, parameter for a physical uplink shared channel, PUSCH in a 2-step random access procedure where the at least one DMRS parameter indicates a plurality of DMRS ports. The method includes determining (Block S148), such as via determiner unit 34, processing circuitry 84, processor 86 and/or radio interface 82, a subset of the plurality of DMRS ports for the PUSCH in the 2-step random access procedure.

In some embodiments, the determination of the subset of the plurality of DMRS ports is based on selecting a plurality of antenna ports from a plurality of code-division multiplexing, CDM, groups. In some embodiments, the determination of the subset of the plurality of DMRS ports includes: determining a first antenna port index of a first CDM group of the plurality of CDM groups that has a smallest index value among the first CDM group; selecting a first antenna port corresponding to the first antenna port index for inclusion in the subset of the plurality of DMRS ports; determining a second antenna port index of a second CDM group of the plurality of CDM groups that has a smallest index value among the second CDM group; and selecting a second antenna port corresponding to the second antenna port index for inclusion in the subset of the plurality of DMRS ports. In some embodiments, the selection of the plurality of antenna ports includes: interleaving the selection of the plurality of antenna ports among the plurality of CDM groups based at least on an antenna port index in each CDM group.

In some embodiments, the interleaving of the selection of the plurality of antenna ports begins at the smallest index value of an antenna port index in each CDM group. In some embodiments, the at least one DMRS parameter indicates a plurality of DMRS sequence initializations, and the wireless device 22 is further configured to select a DMRS sequence initialization from the plurality of DMRS sequence initialization for use with the subset of the plurality of DMRS ports. In some embodiments, the selection of the DMRS sequence initialization is based on at least one of: a physical random access channel, PRACH, occasion for transmission of a preamble of the 2-step random access procedure; an index of the preamble of the 2-step random access procedure; and an index of a PUSCH resource unit.

In some embodiments, the wireless device 22 is further configured to cause transmission of a physical channel in the 2-step random access procedure according to the determined subset of the plurality of DMRS ports. In some embodiments, the transmission of the physical channel in the 2-step random access procedure corresponds to transmission of a message A, msgA, in the PUSCH during the 2-step random access procedure.

Having generally described arrangements for Physical Uplink Shared Channel (PUSCH) Demodulation Reference Signal (DMRS) design in random access, such as, for example, a 2-step random access, functions and processes are provided as follows, and which may be implemented by the network node 16, wireless device 22 and/or host computer 24.

Some embodiments provide arrangements for design of DMRS configuration for msgA PUSCH for 2-step random access. Some embodiments consider the determination of both the DMRS port and the DMRS sequence. Some embodiments describe the general msgA PUSCH structure and further address the detailed DMRS design.

### PUSCH Occasion (PO)

In some embodiments, MsgA PUSCH may be transmitted in time-frequency resource locations referred to as PUSCH occasions (POs), where each PUSCH occasion occupies a contiguous set of subcarriers and symbols and includes multiple PUSCH resource units (PUSCH RUs), as is shown, for example, in FIG. 17. A PUSCH resource unit (‘PUSCH RU’) is defined as the PUSCH occasion (‘PO’) and DMRS port/DMRS sequence initializations used for a msgA payload transmission. The example shown in FIG. 17 includes two DMRSs, and therefore two PUSCH RUs in the PO, where DMRS_{k,0} and DMRS_{k,1} are the first and second DMRS, respectively. In some embodiments, the DMRS can be determined according to the size of the PO, which is what the index ‘k’ refers to in DMRS_{k,0} and DMRS_{k,1} in FIG. 17. This use of multiple DMRS ports and/or DMRS sequence initializations can be used (e.g., by network node 16) to receive (e.g., via radio interface 62) multiple PUSCHs that are transmitted (e.g., by radio interface 82) from different WDs 22, which may be referred to as Multi-user Multiple-input Multiple-output (MU-MIMO) reception for msgA PUSCH. Such MU-MIMO operation may improve spectral efficiency by supporting more WD 22 traffic per PO.

In some embodiments, a set of resources including multiple PUSCH occasions is defined, which may be referred to as a ‘msgA PUSCH set’ (see for example FIG. 18), where,
A msgA PUSCH set occurs periodically and has a known length in symbols and position in frequency; and/or
A msgA PUSCH set can include multiple POs contiguous in frequency and in time (including guard band or period if defined).
In some embodiments, PUSCH RUs and POs may have ‘K’ Physical Resource Blocks (PRBs) per OFDM symbol, where K can vary. In some embodiments, K can be any number.

In some embodiments, a given PRB of a msgA PUSCH set can include PUSCH RUs with different size, and K may be identified, indicated and/or determined according to which preamble is used. In some embodiments, if a PRB includes PUSCH RUs with different size K, DMRS IDs may be a function of size. In some embodiments, different DMRS sequence initializations may be used (e.g., by WD 22) for msgA DMRS antenna ports, in which case a combination of a given DMRS port and its sequence initialization may be referred to as a DMRS port instance.

In some embodiments, a PUSCH resource unit may therefore be defined as a PO and a DMRS port instance used with the PO. In some embodiments, the number of DMRS port instances used for each PO, or equivalently the number of PUSCH RUs per PO, is the same for all POs in a msgA PUSCH set. In such embodiments, the total number of DMRS port instances used for all sizes is N_{DMRS}^{tot}=N_{RUs_per_PO}·N_{sizes}, and the number of PUSCH RUs available for all PUSCH occasion sizes in a msgA PUSCH set, N_{PRU}, can be expressed as, for example,

N_{PRU}=N_{RUS_per_PO}Σₖ₌₁^{N}^{_{sizes}}N_{PO}(k),

Where N_{RUS_per_PO} is the number of PUSCH RUs for each PO, N_{sizes} is the number of PUSCH occasion sizes per msgA PUSCH set, and N_{PO}(k) is the number of PUSCH occasions for the k^{th} size.

In at least contention based operation, a WD 22 may randomly select a PUSCH RU. This may be performed directly (e.g., by processing circuitry 84 of WD 22) by selecting an index ‘n’ out of the set of PUSCH RUs in a msgA PUSCH set. Alternatively, a WD 22 may randomly select (e.g., by processing circuitry 84 of WD 22) a msgA preamble that is mapped to a PUSCH RU in order to indirectly select a PUSCH RU.

### DMRS Port Determination for msgA PUSCH

It should be noted that in 3GPP Rel-15, the DMRS port for msg3 is always 0. By contrast, it is considered that, in 3GPP Rel-16 for 2-step RACH operation, different DMRS ports, different DMRS sequence initialization, or a combination of the two will be used for PUSCH RUs occupying the same PO. In some embodiments, some mechanisms are therefore provided herein to determine the DMRS port and sequence initialization to be used for each PUSCH RU.

As discussed above, it has been considered for 3GPP Rel-16 2-step RACH that a number of DMRS symbols, ports, and/or sequences per PO for msgA PUSCH transmission may be part of 2-step RACH configuration signaling (e.g., via radio interface 62 and/or radio interface 82), depending on if some or all of these are specified. However, the details of how ports and sequences are to be determined have not yet been addressed.

In some embodiments of the present disclosure, the maximum number of DMRS ports is a function of the DMRS configuration in, e.g., 3GPP Rel-15 NR. If less than the maximum number of ports for the configuration is used, some mechanism may be used to determine the subset used in the msgA PUSCH configuration. Therefore, in the following embodiments, a subset of the maximum number of PUSCH DMRS ports in a DMRS configuration are used for msgA PUSCH transmissions.

As discussed above, DMRS ports may be multiplexed using one or more of at least the following 3 different mechanisms: 1) frequency domain multiplexing (FDM) where different ports occupy different subcarriers, 2) code domain multiplexing in frequency (FD-CDM) where ports are spread over subcarriers OFDM symbols, and 3) code domain multiplexing in time (TD-CDM) where ports are spread over OFDM symbols. These 3 different multiplexing methods are not equally robust to different impairments. For example, ports multiplexed with FD-CDM will mutually interfere in the presence of delay spread in a radio channel, while ports multiplexed with TD-CDM will mutually interfere when there is a Doppler shift or spread in the channel. FDM is generally more robust than FD-CDM or TD-CDM, since the cyclic prefix tends to mitigate inter-subcarrier interference, although large Doppler shifts or large timing offsets may lead to inter-subcarrier interference.

In some embodiments, since different DMRS ports interfere differently according to how the DMRS ports are multiplexed, it can be beneficial to use a subset of antenna ports that are multiplexed in the most robust way. In common radio channel conditions, FDM can be the most robust, followed by FD-CDM, and then TD-CDM. Consequently, in some embodiments, subsets may be constructed/designed/configured such that ports are first FDM'd (i.e., multiplexed by FDM), FD-CDM'd (i.e., multiplexed by FD-CDM), and then TD-CDM'd (i.e., multiplexed by TD-CDM). This can be performed using the port numbering for 3GPP Rel-15 NR by interleaving the DMRS ports according to their CDM group. Therefore, in an embodiment a subset of antenna ports for msgA PUSCH transmission may be constructed/designed/configured by first including the first antenna port in each CDM group of the DMRS configuration in the subset, then including the second antenna port in each CDM group in the subset, and so on until the subset contains the desired number of ports. The ports in each CDM group occupy a set of subcarriers that is not occupied by other CDM groups.

In some aspects, this embodiment may alternatively be expressed by Table below. If msgA PUSCH uses DMRS type 1, the first row determines the subset, while if msgA PUSCH uses type 2, the second row determines the subset. In some embodiments, the subset includes elements in the row, starting with the first column and continuing until the column whose header matches the number of DMRS ports in the subset. For example, a Type 1 DMRS with 5 ports used for msgA PUSCH occasions would have ports {0,2,1,3,4}, while a Type 2 DMRS with 7 ports would have ports {0,2,4,1,3,5,6}.

TABLE 1
DMRS port subsets

| | Number of DMRS ports in subset | | | | | | | | | | | |
|---|---|---|---|---|---|---|---|---|---|---|---|---|
| DMRS Type | 1 | 2 | 3 | 4 | 5 | 6 | 7 | 8 | 9 | 10 | 11 | 12 |
| 1 | 0 | 2 | 1 | 3 | 4 | 6 | 5 | 7 | — | — | — | — |
| 2 | 0 | 2 | 4 | 1 | 3 | 5 | 6 | 8 | 10 | 7 | 9 | 11 |

In a similar embodiment, a DMRS antenna port subset for transmitting (e.g., by WD 22) with a physical channel is constructed with at least a first and a second step. The first step includes including in the subset an antenna port with a smallest port index in a first CDM group of the DMRS as a first antenna port in the subset. The second step includes including in the subset an antenna port with a smallest port index in a second CDM group of the DMRS as a next antenna port in the subset. In some embodiments, additionally, the second step may be repeated until an antenna port of each CDM group of the DMRS has been included in the subset. A third and a fourth step may additionally be performed (e.g., by WD 22). The third step may include including in the subset an antenna port with a next smallest port index in the first CDM group of the DMRS. The fourth step may include including in the subset an antenna port with a next smallest port index in the second CDM group of the DMRS as a next antenna port in the subset. In some embodiments, additionally, steps 1, 2, and 3 may have a first sequence initialization value and additional antenna ports are included according to any of steps 1, 2, and 3, where the additional antenna ports have a second sequence initialization value.

In a similar embodiment, a subset of antenna ports for msgA PUSCH transmission is constructed/configured/designed by first including antenna ports that are frequency division multiplexed, then including antenna ports that are code division multiplexed over subcarriers, then including antenna ports that are code division multiplexed over time.

In an alternative embodiment, a subset of antenna ports for msgA PUSCH transmission is constructed configured/designed by first including antenna ports that are frequency division multiplexed, then including antenna ports that are code division multiplexed over time, then including antenna ports that are code division multiplexed over subcarriers.

### msgA DMRS Sequence Calculation and Initialization Without Transform Precoding

In some embodiments, when the transform precoding is not enabled, the DMRS sequence r(n) used for msgA PUSCH may be generated according to, for example, clause 6.4.1.1.1.1 of 3GPP Technical Specification (TS) 38.211, V15.6.0 using:

$$r ( n ) = \frac{1}{\sqrt{2}} ( 1 - 2 \cdot c ( 2 n ) ) + j \frac{1}{\sqrt{2}} ( 1 - 2 \cdot c ( 2 n + 1 ) ) ,$$

where the pseudo-random sequence c(i) is defined in clause 5.2.1 of 3GPP TS38.211

V15.6.0. The pseudo-random sequence generator may be initialized with

cᵢₙᵢₜ=(2¹⁷(N_{symb}^{slot}n_{s,f}^{μ}+l+1)(2N_{ID}ⁿ^{_{SCID}}+1)+2N_{ID}ⁿ^{_{SCID}}+n_{SCID})mod 2³¹

where l is the OFDM symbol number within the slot, n_{sf}^{μ} is the slot number within a frame, and
N_{ID}⁰, N_{ID}¹∈{0, 1, . . . , 65535};
N_{ID}ⁿ^{_{SCID}}is a function of one or more of the below parameters:
   Cell ID of current cell N_{ID}^{cell};
   Preamble id P_{ID} of the preamble mapped to corresponding PUSCH occasion;
   Index of the PUSCH occasion for the transmission of this DMRS; and
   Number of PUSCH occasions reserved for msgA PUSCH at the same time instance.

In some embodiments, the quantity n_{SCID}∈{0,1} can be configured or fixed in specification, if present, otherwise n_{SCID}=0 or 1.

As an example, the below formula can be used for the parameter configuration of the DMRS,

n_{SCID}=0,

N_{ID}⁰=N_{ID}^{cell}+P_{ID}.

### msgA DMRS Sequence Calculation and Initialization with Transform Precoding

When transform precoding is enabled for msgA PUSCH transmission, the reference-signal sequence r(n) may be generated according to, for example, clause 6.4.1.1.1.1 of 3GPP TS 38.211 V15.6.0 using:

r(n)=r_{u,v}^{(α,δ)}(n)

n=0, 1, . . . , M_{sc}^{PUSCH}/2^{δ}−1′

where r_{u,v}^{(α,δ)}(m) is given, for example, by, for example, clause 5.2.2 of 38.211 V15.6.0 with δ=1, and α, u, v may be determined with one or more of the following embodiments.

In some embodiments, a set of alpha values is predetermined for the generation of a set of DMRS sequences.

In some embodiments, a set of alpha values is determined (e.g., by WD 22 and/or network node 16) by the preambles mapped to the corresponding PUSCH occasion for the transmission of the msgA PUSCH.

In some embodiments, the sequence group is determined (e.g., by WD 22 and/or network node 16) or is a function of preamble ID.

In some embodiments, a sequence group pattern is defined for the multiple DMRS sequence generation.

For example, 4 preambles are mapped to 4 DMRS sequences and 1 DMRS port in one PUSCH occasion, the sequence group values u∈{0, 1, 2, 3} are used for this PUSCH occasion for generating 4 DMRS sequences, and the 4 DMRS sequences with u=0, 1, 2, 3 respectively are mapped to the preambles based on e.g., an order of the preamble IDs, e.g., based on the increasing values of preamble IDs.

The same method can be applied on the sequence v in a group. In some embodiments, the sequence and/or the group hopping is associated to the preamble IDs mapped to this PUSCH occasion.

As an example, the formula below can be applied for the grouping hopping,

f_{gh}=(Σₘ₌₀⁷2^{m}c(8(N_{symbol}^{slot}n_{sf}^{u}+l)+m)+P_{ID})mod 30,

where the P_{ID} is the ID of the preamble corresponding to the msgA PUSCH, c(i) is a pseudo-random sequence defined by, for example, clause 5.2.1 of 38.211, V15.5.0, and can be initialized with a DMRS ID n_{ID}^{RS}, e.g., equal to the cell ID, at the beginning of each radio frame.

In some embodiments, the sequence and/or group hopping can be always enabled, or can be enabled based on signaling from the network node 16, e.g., in system messages.

In some embodiments, the sequence group u is a function of a preamble ID P_{ID} in addition to being a function of a group hopping value f_{gh} and a DMRS ID value n_{ID}^{RS}. As an example,

u=(f_{gh}+n_{ID}^{RS}+P_{ID})mod 30.

In another embodiment, the n_{ID}^{RS} used to determine sequence group u is a function of cell ID N_{ID}^{cell} and/or preamble ID P_{ID}. For example:

u=(f_{gh}+n_{ID}^{RS})mod 30, where n_{ID}^{RS}=N_{ID}^{cell}+P_{ID}.

In some embodiments, sequence and/or group hopping is always disabled.

In some embodiments, the same DMRS sequence is applied as that used for msg3 PUSCH when transform precoding is enabled for the msgA PUSCH.

### PRACH Preamble Mapping to DMRS Port and Sequence Initialization

In some embodiments, antenna ports are mapped (e.g., by WD 22 and/or network node 16) to POs as part of a mapping of PRACH preambles to PUSCH RUs. In some embodiments, the preambles from an RO map to PUSCH RUs sequentially M at a time may:
Step 1: Map to frequency of PUSCH RUs.
Step 2: Map to antenna ports of each PUSCH occasion.
   Map the first Nₚₒᵣₜ(k) preambles to antenna ports p=0 . . . Nₚₒᵣₜ(k)−1 with sequence initialization Nᵢₙᵢₜ^{seq}=X, the next Nₚₒᵣₜ(k) preambles to antenna ports p=0 . . . Nₚₒᵣₜ(k)−1 with sequence initialization Nᵢₙᵢₜ^{seq}=X+1, and so on until Nₚₒᵣₜ(k)·N_{seq}(k) preambles have been mapped, where X is a non-negative integer, Nₚₒᵣₜ(k) is a number of antenna ports with a given sequence initialization per PUSCH occasion with size index k, and N_{seq}(k) a number of antenna port sequence initializations per PUSCH occasion with size index k.
Step 3: If M ports are not mapped to each PUSCH RU, then return to step 1.
   M≥1 is an integer number of preambles for each PUSCH RU. If M=1, this step has no effect on the preamble mapping, and may be omitted.
Step 4: Map to the PUSCH RU (and PUSCH occasion) time/frequency size.
Step 5: Map to the OFDM symbol(s) containing the PUSCH.

Because Step 2 above first maps to antenna ports, if N_{seq}(k)=1, all antenna ports mapped to the PUSCH occasion will use the same sequence and therefore will be transmitted (e.g., by radio interface 82 of WD 22) in an orthogonal manner. Consequently, different WDs 22 transmitting in the same PO with distinct preambles will transmit orthogonal antenna ports. These orthogonal antenna ports can mutually interfere less than when different antenna ports use different sequence initialization, thereby improving DMRS channel estimation performance compared to when antenna ports with different sequence initialization are used. In some embodiments, the network node 16 may use the determined DMRS port/sequence to perform the channel estimation when receiving the MsgA PUSCH.

In some embodiments, Nₚₒᵣₜ(k) is equal to the number of antenna ports supported by a DMRS configuration used for a PO. This may be advantageous in that the number of orthogonal ports used for the PO is maximized. In other embodiments, Nₚₒᵣₜ(k) is signaled to the WD 22 by the network node 16, in which case it may be less than the number of antenna ports supported by a DMRS configuration used for a PO. This may be used to allow WDs 22 transmitting in the PRBs used by the PO to have different orthogonal antenna ports. For example, if two different size POs can be transmitted (e.g., by radio interface 82 of WD 22) in the same PRBs, Nₚₒᵣₜ(1)=2 and Nₚₒᵣₜ(1)=2 may be set for the two size POs, respectively, and the same sequence initialization can be used for both the sets of antenna ports associated with the two sizes, that is, Nᵢₙᵢₜ^{seq}=X for both size POs. Antenna ports 0 & 2 could be allocated to PO size 1 and ports 1 & 3 could be allocated to PO size 2. Then, in the PRBs that both sizes occupy, the antenna ports are orthogonal, and so PUSCHs with different sizes can have low mutual interference among their DMRS ports.

A second benefit of Step 2 above may be that a flexible number of antenna ports and sequence initializations can be mapped to PUSCH occasions. Since each PUSCH RU should be associated with a preamble, using fewer antenna port—sequence combinations allows fewer preambles to be used, and therefore preamble overhead can be reduced.

In some embodiments, the PUSCH is transmitted (e.g., by radio interface 82 of WD 22) with transform precoding disabled (that is, using CP-OFDM), and so the DMRS sequence is initialized using the Rel-15 variable N_{ID}⁽ⁿ^{_{SCID}}⁾, and Nᵢₙᵢₜ^{seq}=N_{ID}⁽ⁿ^{_{SCID}}⁾ in Step 2 for these embodiments. In other embodiments, the PUSCH is transmitted with transform precoding enabled (that is, using DFT-S-OFDM), and so and Nᵢₙᵢₜ^{seq}=n_{ID}^{RS} in Step 2 for these embodiments.

In some such embodiments, the non-negative integer X is a cell identifier N_{ID}^{cell} for the PUSCH DMRS. One advantage of setting X=N_{ID}^{cell} in this way is that X does not need to be signaled to the WD 22 in such embodiments. Since 16-bit values are used for DMRS sequence initialization in Rel-15 NR, and since X may need to be signaled (e.g., by radio interface 62 of network node 16) in system information where 16-bits is a significant amount of overhead, this embodiment can reduce higher layer signaling overhead. Another advantage of such embodiments may be that other WDs 22 also simultaneously transmitting PUSCH in the same PRBs and in the same cell can have orthogonal antenna ports when they use the same DMRS sequence initialization but different antenna ports. That is, in such embodiments, it may be possible to use MU-MIMO between WDs 22 that transmit msgA PUSCH and other WDs 22.

In an embodiment generalizing Step 2, a WD 22 uses one of two modes to determine (e.g., by processing circuitry 84) an antenna port and transmits (e.g., by radio interface 82 of WD 22) a physical channel with the determined antenna port. In some embodiments, the step of determining the antenna port may include selecting (e.g., by processing circuitry 84) a random access preamble that is associated with the antenna port and a physical channel resource in which the physical channel is transmitted. In some embodiments, in a first mode, the determined antenna port is from a single antenna port set, and in a second mode, the determined antenna port is from a plurality of antenna port sets. In some embodiments, the single set of antenna ports is formed through initializing each antenna port in the single set with a first sequence initialization value. The plurality of antenna port sets is formed through initializing each antenna port in the single set with the first sequence initialization value and initializing each antenna port in a second set of antenna ports with a second sequence initialization value.

In some embodiments, the WD 22 may further transmit the physical channel with the determined antenna port in a physical channel resource of any of a plurality of physical channel resources. In some embodiments, the WD 22 receives signaling (e.g., from network node 16) identifying the plurality of physical channel resources in a configuration to be used in a random access procedure. Additionally or alternatively, the WD 22 may receive signaling (e.g., from network node 16) identifying a number of antenna ports in the single set of antenna ports. Additionally or alternatively, the WD 22 may receive signaling (e.g., from network node 16) identifying a number of sequence initialization values to be used for the plurality of antenna port sets.

### DMRS Port and Sequence Determination from PUSCH RU Location

In some embodiments, PUSCH RUs are indexed such that all DMRS instances for a given PUSCH RU have consecutive indices. In such embodiments, an index of an antenna port, p(k) to be used for a PUSCH RU is determined at least in part according to a modulo division of an index of the PUSCH RU, n_{PRU}, by a number of antenna ports per PO with size index k, Nₚₒᵣₜ(k), which may be expressed as, for example:

p(k)=n_{PRU} mod Nₚₒᵣₜ(k),

where n_{PRU} is a non-negative integer identifying one of a plurality of PUSCH RUs in which the WD 22 may transmit (such as via radio interface 82) a msgA PUSCH. A single sequence initialization may be used for all antenna ports that may be transmitted in the PUSCH RU.

In some embodiments, Nₚₒᵣₜ(k) may be the same for all size indices k, and so an index of an antenna port to be used for a PUSCH RU is determined according to a modulo division of an index of the PUSCH RU, n_{PRU}, by a number of antenna ports per PO, Nₚₒᵣₜ, which may be expressed as, for example:

P=N_{PRU} mod Nₚₒᵣₜ.

In some embodiments, a plurality of sequence initializations may be used for antenna ports that may be transmitted in a PUSCH RU. In such embodiments, a scrambling initialization of the plurality of scrambling initializations of a PUSCH RU for an antenna port p(k) may be determined from an index of the PUSCH RU n_{PRU} by rounding down a ratio, and performing a modulo division of the result by a number of DMRS sequence initializations per PO, N_{seq}(k), where the ratio is a division of the PUSCH RU index by the number of antenna ports per PO with size index k, Nₚₒᵣₜ(k). The scrambling initialization, N_{ID}⁰, may be expressed as, for example:

N_{ID}⁰=N_{ID}^{cell}+└n_{PRU}/Nₚₒᵣₜ(k)┘mod N_{seq}(k),

where the antenna port for which the scrambling initialization is to be used is determined from the index of the PUSCH RU using any of the methods above.

In some aspects, a benefit of the above embodiment may be that the number of distinct scrambling initializations per PO can be limited, since it is set by N_{seq}(k). Advanced receiver implementations may be capable of blindly detecting among a limited number of DMRS sequence initialization hypotheses, and so such implementations can be made feasible with a design that limits N_{seq}(k).

In some embodiments, Nₚₒᵣₜ(k) and N_{seq}(k) may be the same for all size indices k. In such embodiments, an index of a scrambling initialization of the plurality of scrambling initializations of a PUSCH RU for an antenna port p(k) may be determined from an index of the PUSCH RU n_{PRU} according to:

N_{ID}⁰=N_{ID}^{cell}+└n_{PRU}/Nₚₒᵣₜ┘mod N_{seq}

wherein the antenna port for which the scrambling initialization is to be used is determined from the index of the PUSCH RU using any of the methods above.

In some embodiments, PUSCH RUs with different sizes may occupy the same PRBs. In such cases, a distinct set of antenna ports or antenna port initializations may be used for each size of the PUSCH RUs. An integer antenna port offset may be added to an antenna port index according to the size of the PUSCH RU. This may be expressed as, for example:

p(k)=n_{PRU} mod Nₚₒᵣₜ(k)+Σ_{k′=1}^{k-1}Nₚₒᵣₜ(k′),

where p(k), n_{PRU}, Nₚₒᵣₜ(k) are defined according to the embodiments above.

In similar embodiments, an antenna port sequence initialization offset may be added to an index of a scrambling initialization of a plurality of scrambling initializations of a PUSCH RU in order to differentiate different size PUSCH RUs. This may be expressed as, for example:

N_{ID}⁰=N_{ID}^{cell}+└n_{PRU}/Nₚₒᵣₜ(k)┘mod N_{seq}(k)+Σ_{k′=1}^{k-1}N_{seq}(k′),

where n_{PRU},Nₚₒᵣₜ(k), and N_{seq}(k) are defined according to the embodiments above, and where the antenna port index to which the initialization applies may be determined as the following, also in accordance with the embodiments above:

p(k)=n_{PRU} mod Nₚₒᵣₜ(k).

Some embodiments of the present disclosure provide arrangements for the detailed design of DMRS configuration for msgA PUSCH for 2-step random access. Some embodiments may consider the determination of both the DMRS port and the DMRS sequence. Some embodiments may include one or more of the following, which may be performed by WD 22 and/or network node 16:

1. (msgA uses two modes: one mode with a single set of orthogonal DMRS and one sequence initialization, and the other mode with multiple sequence initializations, with one initialization for all ports) A method in a WD 22 for determining resources to transmit a physical channel in a random access procedure, comprising:
a. selecting a random access preamble that is associated with an antenna port and with a physical channel resource in which the physical channel is transmitted, wherein one or more of:
   i. the associated antenna port is from one of either a single set or a plurality of antenna port sets;
   ii. the single set of antenna ports is formed through initializing each antenna port in the single set with a first sequence initialization value; and/or
   iii. the plurality of antenna port sets is formed through initializing each antenna port in the single set with the first sequence initialization value and initializing each antenna port in a second set of antenna ports with a second sequence initialization value; and
b. transmitting the selected random access preamble; and
c. transmitting the physical channel with the determined antenna port in a physical channel resource of any of a plurality of physical channel resources.

2. (Also signal the number of orthogonal ports Nₚₒᵣₜ(k)) The method of 1, further comprising receiving a signaling configuration indicating a number of antenna ports in the single set of antenna ports.

3. (Also signal the number of sequence initializations N_{seq}(k)) The method of 1, or 2. further comprising receiving a signaling configuration indicating a number of sequence initialization values to be used for the plurality of antenna port sets.

4. (Receive msgA PUSCH set configuration) The method of any of 1-3, further comprising receiving a signaling configuration indicating the plurality of physical channel resources.

5. (Map DMRS ports, starting with the first port of each of a first and a second CDM group) A method of constructing a DMRS antenna port subset for transmitting with a physical channel, comprising:
a. a first step of including in the subset an antenna port with the smallest port index in a first CDM group of the DMRS as a first antenna port in the subset, and
b. a second step of including in the subset an antenna port with the smallest port index in a second CDM group of the DMRS as a next antenna port in the subset.

6. (Next map the first port of remaining CDM groups) The method of 5, further comprising repeating the second step until an antenna port of each CDM group of the DMRS has been included in the subset.

7. (Next map the first port of remaining CDM groups) The method of 6, further comprising including a third step of including in the subset an antenna port with the next smallest port index in the first CDM group of the DMRS and a fourth step of including in the subset an antenna port with the next smallest port index in the second CDM group of the DMRS as a next antenna port in the subset.

8. (Next map the ports using a new sequence initialization value) The method of 7, wherein ports in the subset as a result of steps 1, 2, and 3 have a first sequence initialization value, and further comprising including additional antenna ports according to any of steps 1, 2, and 3 wherein the additional antenna ports have a second sequence initialization value.

### SOME EXAMPLES

Example A1. A network node 16 configured to communicate with a wireless device 22 (WD 22), the network node 16 configured to, and/or comprising a radio interface and/or comprising processing circuitry 68 configured to:

signal an indication of at least one Demodulation Reference Signal (DMRS) parameter for a 2-step random access procedure; and

receive a physical channel in the 2-step random access procedure according to the at least one DMRS parameter.

Example A2. The network node 16 of Example A1, wherein one or more of:

the at least one DMRS parameter is indicated in a physical uplink shared channel (PUSCH) configuration;

the at least one DMRS parameter is indicated based at least in part on a preamble-to-PUSCH resource unit mapping;

the at least one DMRS parameter is indicated based at least in part on a fixed parameter; and/or

the at least one DMRS parameter is indicated based at least in part on a pre- defined expression.

Example A3. The network node 16 of any one of Examples A1 and A2, wherein the at least one DMRS parameter one or more of:

includes one or more parameters defining a msgA PUSCH set;

is associated with a preamble used for the random access procedure;

includes a DMRS port and/or a DMRS port subset;

includes a DMRS sequence initialization;

includes orthogonal frequency division multiplexing (OFDM) symbols to be used for physical uplink shared channel (PUSCH);

is associated with a code division multiplexing (CDM) grouping of a DMRS configuration used for a physical uplink shared channel (PUSCH) occasion; and/or

is associated with a mode used to determine DMRS antenna port and sequence initialization.

Example B 1. A method implemented in a network node 16, the method comprising:

signaling an indication of at least one Demodulation Reference Signal (DMRS) parameter for a 2-step random access procedure; and

receiving a physical channel in the 2-step random access procedure according to the at least one DMRS parameter.

Example B2. The method of Example B1, wherein one or more of:

the at least one DMRS parameter is indicated in a physical uplink shared channel (PUSCH) configuration;

the at least one DMRS parameter is indicated based at least in part on a preamble-to-PUSCH resource unit mapping;

the at least one DMRS parameter is indicated based at least in part on a fixed parameter; and/or

the at least one DMRS parameter is indicated based at least in part on a pre-defined expression.

Example B3. The method of any one of Examples B1 and B2, wherein the at least one DMRS parameter one or more of:

includes one or more parameters defining a msgA PUSCH set;

is associated with a preamble used for the random access procedure;

includes a DMRS port and/or a DMRS port subset;

includes a DMRS sequence initialization;

includes orthogonal frequency division multiplexing (OFDM) symbols to be used for physical uplink shared channel (PUSCH);

is associated with a code division multiplexing (CDM) grouping of a DMRS configuration used for a physical uplink shared channel (PUSCH) occasion; and/or

is associated with a mode used to determine DMRS antenna port and sequence initialization.

Example C1. A wireless device 22 (WD 22) configured to communicate with a network node 16, the WD 22 configured to, and/or comprising a radio interface 82 and/or processing circuitry 84 configured to:

determine at least one Demodulation Reference Signal (DMRS) parameter for a 2-step random access procedure; and

transmit a physical channel in the 2-step random access procedure according to the determined at least one DMRS parameter.

Example C2. The WD 22 of Example C1, wherein the WD 22 and/or the radio interface 82 and/or the processing circuitry 84 is further configured to determine the at least one DMRS parameter according to one or more of:

a physical uplink shared channel (PUSCH) configuration received from the network node;

a preamble-to-PUSCH resource unit mapping;

a fixed parameter; and/or

a pre-defined expression.

Example C3. The WD 22 of Example of any one of C1 and C2, wherein the at least one DMRS parameter one or more of:

includes one or more parameters defining a msgA PUSCH set;

is determined according to a selected preamble for the random access procedure;

includes a DMRS port and/or a DMRS port subset;

includes a DMRS sequence initialization;

includes orthogonal frequency division multiplexing (OFDM) symbols to be used for physical uplink shared channel (PUSCH);

is determined according to a code division multiplexing (CDM) grouping of a DMRS configuration used for a physical uplink shared channel (PUSCH) occasion; and/or

is determined according to a mode used to determine DMRS antenna port and sequence initialization.

Example D1. A method implemented in a wireless device 22 (WD 22), the method comprising:

determining at least one Demodulation Reference Signal (DMRS) parameter for a 2-step random access procedure; and

transmitting a physical channel in the 2-step random access procedure according to the determined at least one DMRS parameter.

Example D2. The method of Example D1, wherein determining the at least one DMRS parameter further comprises determining the at least one DMRS parameter according to one or more of:

a physical uplink shared channel (PUSCH) configuration received from the network node;

a preamble-to-PUSCH resource unit mapping;

a fixed parameter; and/or

a pre-defined expression.

Example D3. The method of Example of any one of D1 and D2, wherein the at least one DMRS parameter one or more of:

includes one or more parameters defining a msgA PUSCH set;

is determined according to a selected preamble for the random access procedure;

includes a DMRS port and/or a DMRS port subset;

includes a DMRS sequence initialization;

includes orthogonal frequency division multiplexing (OFDM) symbols to be used for physical uplink shared channel (PUSCH);

is determined according to a code division multiplexing (CDM) grouping of a DMRS configuration used for a physical uplink shared channel (PUSCH) occasion; and/or

is determined according to a mode used to determine DMRS antenna port and sequence initialization.

As will be appreciated by one of skill in the art, the concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the disclosure may take the form of a computer program product on a tangible computer usable storage medium having computer program code embodied in the medium that can be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

Abbreviations that may be used in the preceding description include:

| Abbreviation | Explanation |
|---|---|
| DCI | Downlink Control Information |
| DMRS | Demodulation Reference Signal |
| FD-OCC | Orthogonal Cover Code in Frequency Domain |
| MA | Multiple Access |
| MAI | Multiple Access Interference |
| MSE | Mean Squared Error |
| MMSE | Minimum Mean Squared Error |
| NOMA | Non-Orthogonal Multiple Access |
| NR | New radio |
| NW | Network |
| OCC | Orthogonal Cover Code |
| OMA | Orthogonal Multiple Access |
| OFDM | Orthogonal Frequency Division Multiplexing |
| PUSCH | Physical Uplink Shared Channel |
| PDSCH | Physical Downlink Shared Channel |
| PXSCH | PUSCH or PDSCH |
| TD-OCC | Orthogonal Cover Code in Time Domain |
| WSMA | Welch Bound Equality based Multiple Access |

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings without departing from the scope of the following claims.

1. A wireless device configured to communicate with a network node, the wireless device configured to:
receive an indication indicating at least one Demodulation Reference Signal, DMRS, parameter for a physical uplink shared channel, PUSCH in a 2-step random access procedure, the at least one DMRS parameter indicating a plurality of DMRS ports; and
determine a subset of the plurality of DMRS ports for the PUSCH in the 2-step random access procedure.

2-16. (canceled)

17. A method implemented by a wireless device that is configured to communicate with a network node, the method comprising:
receiving an indication indicating at least one Demodulation Reference Signal, DMRS, parameter for a physical uplink shared channel, PUSCH in a 2-step random access procedure, the at least one DMRS parameter indicating a plurality of DMRS ports; and
determining a subset of the plurality of DMRS ports for the PUSCH in the 2-step random access procedure.

18. The method of claim 17, wherein the determination of the subset of the plurality of DMRS ports is based on selecting a plurality of antenna ports from a plurality of code-division multiplexing, CDM, groups.

19. The method of claim 18, wherein the determination of the subset of the plurality of DMRS ports includes:
determining a first antenna port index of a first CDM group of the plurality of CDM groups that has a smallest index value among the first CDM group;
selecting a first antenna port corresponding to the first antenna port index for inclusion in the subset of the plurality of DMRS ports;
determining a second antenna port index of a second CDM group of the plurality of CDM groups that has a smallest index value among the second CDM group; and
selecting a second antenna port corresponding to the second antenna port index for inclusion in the subset of the plurality of DMRS ports.

20. The method of claim 18, wherein the selection of the plurality of antenna ports includes:
interleaving the selection of the plurality of antenna ports among the plurality of CDM groups based at least on an antenna port index in each CDM group.

21. The method of claim 20, wherein the interleaving of the selection of the plurality of antenna ports begins at the smallest index value of an antenna port index in each CDM group.

22. The method of claim 17, wherein the at least one DMRS parameter indicates a plurality of DMRS sequence initializations; and
the method further comprising selecting a DMRS sequence initialization from the plurality of DMRS sequence initialization for use with the subset of the plurality of DMRS ports.

23. The method of claim 22, wherein the selection of the DMRS sequence initialization is based on at least one of:
a physical random access channel, PRACH, occasion for transmission of a preamble of the 2-step random access procedure;
an index of the preamble of the 2-step random access procedure; and
an index of a PUSCH resource unit.

24. The method of claim 17, further comprising causing transmission of a physical channel in the 2-step random access procedure according to the determined subset of the plurality of DMRS ports.

25. The method of claim 17, wherein the transmission of the physical channel in the 2-step random access procedure corresponds to transmission of a message A, msgA, in the PUSCH during the 2-step random access procedure.

26. A method implemented by a network node that is configured to communicate with a wireless device, the method comprising: signaling an indication indicating at least one Demodulation Reference Signal, DMRS, parameter for a physical uplink shared channel, PUSCH in a 2-step random access procedure, the at least one DMRS parameter indicating a plurality of DMRS ports; and
receiving a physical channel in the 2-step random access procedure according to a subset of the plurality of DMRS ports for the PUSCH in the 2-step random access procedure.

27. The method of claim 26, wherein the subset of the plurality of DMRS ports is based on a plurality of code-division multiplexing, CDM, groups.

28. The method of claim 27, wherein the subset of the plurality of DMRS ports is based on interleaving a selection of a plurality of antenna ports from among the plurality of CDM groups based at least on antenna port indices.

29. The method of claim 28, wherein the interleaving begins at the smallest index value of an antenna port index in each CDM group.

30. The method of claim 26, wherein the at least one DMRS parameter indicates a plurality of DMRS sequence initializations; and
the physical channel in the 2-step random access procedure being received according to a subset of the plurality of DMRS sequence initializations.

31. The method of claim 30, wherein the subset of the plurality of DMRS sequence initializations is based on at least one of:
a physical random access channel, PRACH, occasion for the transmission of a preamble of the 2-step random access procedure;
an index of the preamble of the 2-step random access procedure; and
an index of a PUSCH resource unit.

32. The method of claim 26, wherein the receiving of the physical channel in the 2-step random access procedure corresponds to receiving a message A, msgA, in the PUSCH during the 2-step random access procedure.
